(19) United States
(12) Patent Application Publication
(10) Pub. No.: US 2017/0178180 A1
(43) Pub. Date: Jun. 22, 2017

(54) PRODUCT SUGGESTION FOR PUBLISHER

(71) Applicants: Barbara Ann Stanley, Palo Alto, CA (US); Silvestru Cosmin Negruseri, Mountain View, CA (US); Aaron Rothman, Palo Alto, CA (US); Dwight Porter, Saint Paul, MN (US)

(72) Inventors: Barbara Ann Stanley, Palo Alto, CA (US); Silvestru Cosmin Negruseri, Mountain View, CA (US); Aaron Rothman, Palo Alto, CA (US); Dwight Porter, Saint Paul, MN (US)

(73) Assignee: Google Inc., Mountain View, CA (US)

(21) Appl. No.: 13/550,507

(22) Filed: Jul. 16, 2012

Related U.S. Application Data
(60) Provisional application No. 61/539,914, filed on Sep. 27, 2011.

(51) Int. Cl. G06Q 30/02

(52) U.S. Cl. CPC G06Q 30/0244

(57) ABSTRACT

Embodiments receive an identifier of a publisher that has previously advertised on a web site. Based on the identifier, embodiments provide electronic advertisement products related to the identified publisher.

### CROSS REFERENCE TO RELATED APPLICATIONS

The present application claims the benefit of U.S. Provisional Patent Application No. 61/539,914, filed Sep. 27, 2011, entitled “Yield Management for Direct Sold Publisher Inventory”, which is incorporated herein by reference in its entirety.

### BACKGROUND

Field of the Invention

The present invention relates to a technology to help online advertising publishers coordinate online marketing efforts.

Background

Online publisher inventory, measured in impressions, is generally lumped into products or packages for the purpose of selling. These products and packages may overlap each other, alternatively known as taking from the same impression pool. These products and packages have characteristics such as site, section, location on page, advertisement product size, advertisement product type, audience, etc. Such characteristics affect the value of products and packages.

Many of these characteristics affect the value of all publishers' inventory. For example, in general, larger advertisement product areas will tend to be more valuable. However, some types of inventory may have unique characteristics relevant to their specific Web sites (for example, a bridal slideshow for a wedding attire Web site may have certain ads that relate to brides and certain ads that relate to bridesmaids.)

It can be difficult for online publishers to develop effective strategies for pricing their online publisher inventory. For example, an online publisher may have goals such as to maximize the revenue that he receives from selling his inventory, or to be able to sell as much of his entire inventory as possible.

### BRIEF SUMMARY

Embodiments relate to a technology that provides pricing suggestions and product recommendations for inventory for online advertisers. Embodiments offer multiple techniques for facilitating these goals. For example, some embodiments may offer static price optimization, while others offer dynamic price optimization. In exemplary embodiments, static price optimization corresponds with pricing products and dynamic price optimization corresponds with pricing line items.

The difference between static and dynamic price optimization lies in the timing of when the price optimization occurs. Static price optimization includes price optimization that occurs based on general factors, and such price optimization may be obtained at any time. Dynamic price optimization, by contrast, occurs at point of sale and requires the use of information that is only available as a product is sold.

To use the example of purchasing a car, static price optimization is roughly analogous to determining the list price of the car. Such a list price may be determined based on objective, unchanging factors such as the model, gas mileage, and features of the car. By contrast, dynamic price optimization is based on characteristics that only emerge at the time of purchase, such as the purchaser's budget or particular preferences. Both static and dynamic price optimization help manage online publisher inventory. Various embodiments provide for using static and dynamic price optimization.

1. Providing Pricing Recommendations

Embodiments include a computer-implemented method, a system, and a computer storage medium for providing pricing suggestions for inventory for electronic advertisement products. A request for a rate card is received from a third-party publisher, wherein the third-party publisher offers one or more electronic advertisement products on a webpage associated with the third-party publisher. In response to the request for the rate card, several stages occur. Publisher-provided rate data related to each of the electronic advertisement products is retrieved. Historical sales data and value driver models are identified for each of the one or more electronic advertisement products. Value driver information related to each of the one or more electronic advertisement products based on the publisher-provided rate data, historical sales data, and value driver models is determined. Pricing recommendations are determined for each of the one or more electronic advertisement products based on the value driver information for each of the one or more electronic advertisement products. A rate card that includes the pricing information for each of the one or more electronic advertisement products is provided to the third-party publisher.

Additionally, further embodiments provide alternative capabilities related to the embodiments just discussed. These embodiments include computer-implemented methods, systems, and computer storage media that implement these alternative capabilities. The overall approaches taken in these embodiments are detailed here, and specific implementation details will be discussed below.

2. Product Suggestions For Publishers

Embodiments include a computer-implemented method, a system, and a computer storage medium for providing electronic advertisement products over the Internet. An identifier associated with a first advertiser is received over the Internet from a publisher, wherein the first advertiser is one that has previously digitally advertised on a webpage associated with the publisher. One or more first electronic advertisement products are identified to provide to the publisher based on the identifier. The one or more first electronic advertisement products are provided over the Internet to be displayed for the publisher.

3. Similar Advertiser Suggestion to Publisher

Embodiments include a computer-implemented method, a system, and a computer storage medium for providing electronic identifiers of advertisers over the Internet. An electronic identifier associated with a first advertiser is received over the Internet from a publisher, wherein the first advertiser is one that has previously purchased first electronic advertisement products from the publisher. A second advertiser similar to the first advertiser is identified based on the first electronic advertisement products purchased by the first advertiser and second electronic advertisement products purchased by the second advertiser. An electronic identifier of the second advertiser is provided over the Internet to the publisher.

4. Product Information of Publisher's Product

Embodiments include a computer-implemented method, a system, and a computer storage medium for providing data associated with electronic advertisement products to a publisher over the Internet. An identifier associated with a first advertiser that has previously advertised on a webpage associated with a publisher is received. An indication of a first electronic advertisement product associated with the first advertiser is received. A budget amount for electronic advertisement products is received from the publisher. Data associated with the first electronic advertisement product is provided based on the budget amount, wherein the data includes at least one of a list price that indicates a current rate associated with the first electronic advertisement product, a target price that indicates a desired price that is calculated to be appropriate for the first electronic advertisement product based on the budget, and a floor price that indicates a minimum price that is calculated to be appropriate for the first electronic advertisement product based on the budget.

5. Discount Analyzer

Embodiments include a computer-implemented method, a system, and a computer storage medium for providing one or more electronic advertisement products over the Internet. One or more value drivers associated with an electronic advertisement product are received, wherein each of the value drivers describes a feature associated with a respective electronic advertisement product. A discount rate associated with each one or more electronic advertisement products associated with the one or more value drivers is calculated, wherein the discount rate is a difference between a desired price the publisher had set to sell each electronic advertisement product at and an actual price at which the respective electronic advertisement product is sold. The one or more electronic advertisement products associated with the one or more value drivers and the discount rate associated with each of the plurality of products are provided.

6. Rate Analyzer

Embodiments include a computer-implemented method, a system, and a computer storage medium for providing features of electronic advertisement products over the Internet. An indication is received of a rate type associated with an electronic advertisement product campaign. An indication is received of a webpage associated with a publisher. A list of a plurality of electronic advertisement products associated with the webpage associated with the publisher is provided, wherein each of the plurality of electronic advertisement products is available for purchase by an advertiser. For each of the plurality of electronic advertisement products, one or more features of the respective electronic advertisement products are provided, wherein a feature of an electronic advertisement product is a piece of metadata related to the product, and wherein the features provided are chosen at least partially based on the rate type.

7. Sell-Through Rates for Publisher Products

Embodiments include a computer-implemented method, a system, and a computer storage medium for providing a historical sell-through rate of a price feature set to a publisher. A number of sold impressions for a price feature set of electronic advertisement products is calculated, wherein a price feature set includes electronic advertisement products that are at least one of a same size, a same section, or a same site. A number of available impressions for the price feature set is calculated. An overall sell-through-rate for the price feature set based on the number of sold impressions and the number of available impressions is calculated. The overall sell-through rate to a publisher associated with the price feature set is provided over the Internet.

8. Managing Rate Card

Embodiments include a computer-implemented method, a system, and a computer storage medium for providing a rate card to a publisher over the Internet.

One or more value drivers associated with an electronic advertisement product available for purchase on a webpage associated with a publisher are identified, wherein each value driver is a feature of a respective electronic advertisement product. Weights are determined for each of the value drivers based on previous electronic advertisement products sold by the publisher and the value drivers associated with each of those previous electronic advertisement products. A rate card is generated based on the weights of each of the value drivers. The rate card is provided to the publisher.

9. Pricing a New Product

Embodiments include a computer-implemented method, a system, and a computer storage medium for calculating a price for an electronic advertisement product. An indication to calculate a price for a new electronic advertisement product associated with a publisher is received over the Internet, wherein the new electronic advertisement product can be purchased from the publisher by an advertiser. A selection of one or more value drivers describing the new electronic advertisement product is received, wherein each value driver describes a feature of the new electronic advertisement product, wherein each value driver is associated with a weight. The price for the new electronic advertisement product is calculated based on the selected value drivers and the weight of each selected value driver. The price is provided to the publisher over the Internet.

Further embodiments, features, and advantages of the invention, as well as the structure and operation of various exemplary embodiments of the invention, are described in detail below with reference to accompanying drawings.

### BRIEF DESCRIPTION OF THE FIGURES

The patent or application file contains at least one drawing executed in color. Copies of this patent or patent application with color drawing(s) will be provided by the Office upon request and payment of the necessary fee.

The accompanying drawings, which are incorporated herein and form a part of the specification, illustrate embodiments of the present invention and, together with the description, further serve to explain the principles of the embodiments and to enable a person skilled in the pertinent art to make and use the embodiments.

The drawing in which an element first appears is typically indicated by the leftmost digit or digits in the corresponding reference number. In the drawings, like reference numbers may indicate identical or functionally similar elements.

FIG. 1 is a diagram illustrating an exemplary system.

FIG. 2 is another diagram of an exemplary system.

FIG. 3 is a flowchart of an example method.

FIG. 4 is a screenshot of an example Price Optimizer Pilot.

FIG. 5 is a flowchart of an example method.

FIG. 6 is a flowchart of an example method.

FIG. 7 is a flowchart of an example method.

FIG. 8A-D are screenshots of an example Plan Line Items.

FIG. 9 is a flowchart of an example method.

FIGS. 10A-G are screenshots of an example Products Discount Analyzer.

FIG. 11 is a flowchart of an example method.

FIGS. 12A-B are screenshots of a Rate Model Summary.

FIGS. 13A-B are flowcharts of example methods.

FIG. 14 is a flowchart of an example method.

FIG. 15A is a screenshot of an example Manage Rate Cards.

FIG. 15B is a screenshot of an example Revenue Forecast.

FIG. 16 is a flowchart of an example method.

FIG. 17 is a screenshot of an example Pricing Template.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such a feature, structure, or characteristic in connection with other embodiments whether or not explicitly described.

It should be noted that computer-readable storage medium embodiments may include any physical medium which is capable of encoding instructions that may subsequently be used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

When online advertising publishers sell electronic advertisement products on webpages associated with them, it can be difficult to establish pricing levels for the electronic advertisement products that will maximize revenue from those products. To establish effective pricing levels, online advertising publishers use analytical approaches such as pricing models and rate cards to establish ways of approaching the pricing problem.

Although publishers have defined many characteristics of their products and packages, those characteristics do not necessarily all influence price. The characteristics of the products and packages that actually have a measurable influence on price are called value drivers.

A pricing model consists of a set of recommended (and publisher adjustable) value drivers that directly influence a subset of publisher products and packages. Related to a pricing model is the rate card. Publishers manage one or more rate cards. A rate card is a certain set of value drivers with a set of weightings assigned to the value drivers to help establish and characterize how important each of the value drivers is to the pricing recommendation. Rate cards may be stored as spreadsheets containing information related to the value drivers that provide pricing information and product recommendations for the advertisers' products. Value drivers are characteristics of the advertisers' products that are given various weights and can be used to deduce appropriate prices for rate cards. For example, rate cards may be affected by characteristics of the advertising opportunity, such as season and tier. Embodiments described herein can recommend rate cards to publishers, who can then take the recommendations and modify them as they see fit.

The value drivers can be established by using a number of methods.

In one implementation, review of the publisher's offline rate card can be conducted. An offline rate card generally is based primarily on value drivers while online product and package definitions use more information besides value drivers, making it necessary to incorporate information in addition to basic value driver information. However, this is only a starting point. While it helps to identify some preliminary value drivers, it does not establish how much they actually drive value. It is necessary to complete at least the next method (statistical analysis) regardless of the results of this method (review of the offline rate card).

In one implementation, more value drivers, as well as specific weights for the value drivers, can be determined by regression analysis over previously sold products and packages. Alternatively, other relevant statistical methodologies and algorithms, such as principal component analysis, confidence intervals, support vector machines, gradient descent, and machine learning algorithms may help in the process of determining value drivers. Given sufficient sales data, it is possible not only to determine the value drivers but also to detect the specific weights for the value drivers (i.e., how much they influence price), which may be used to build a pricing model.

In one implementation, pre-existing value driver models may also be used to deduce appropriate value drivers. For example, new publishers lack sales data and do not have well-defined offline rate cards because they have not yet built up a track record for sales of their products that may be used to extrapolate and deduce future plans. In this situation, the best approach is to use an existing model that seems similar to the type of publisher that they are to generate sample data. After generating the modeled sales data, the previous method (statistical analysis) can be used to produce estimates.

It should be noted that there are many other factors (besides the characteristics of the products and the packages) that can act as value drivers. These include such factors as the salesperson, seasonality, industry trends, economic factors, advertiser's industry, impact on sale of other products (especially higher priced products), size and type of audience, predicted sales impact, type of advertiser, size of advertiser spending, available inventory, and so on. Some factors apply to analysis before an advertising campaign begins and some apply at time of sale. Embodiments provide for making pricing recommendations both at point of sale as well as before an advertising campaign begins. These additional features that become value drivers at the time-of-sale can then be used to aid in defining the rate cards. However, they may not be defined in the pricing model. These other value drivers, such as the advertiser, advertiser budget, and available inventory, are used to calculate target and floor prices at the time of sale. These become additional factors besides the pricing model values, but are not available for the publisher to adjust the weights.

In one implementation, a white box pricing model is provided, in that the operation is intended to be as transparent as possible to users. These white box pricing models use value drivers to build one or more pricing models and one or more rate cards. Instead of trying to directly define a price for a particular product or package, the publisher can instead adjust the value drivers, which then become automatically reflected in adjustments to products and packages that share those characteristics.

Such an approach allows for consistent pricing of products and packages. However, the corresponding price changes only impact products and packages covered by the pricing model and rate cards.

Regressions (discussed further below) use linear and log-linear regressions as statistical techniques to determine what factors influence price (i.e., the value drivers) and how much they influence price. The first step is determining which characteristics to track relationships between. Then, linear and log-linear regressions can establish a relationship between two variable sets. Such regression analysis requires historical sales data to analyze.

Linear regression takes two variables, x and y, and uses an assortment of data points to establish the constants that best define a linear relationship between them. Log-linear regression, similarly, finds a linear relationship between the logarithms of two variables x and y, defining an exponential relationship between x and y. Using techniques of statistics and linear algebra, it is possible to take data points and determine criteria that establish a linear or exponential relationship between data points that represent x values and their associated y values.

For example, a linear model may define a slope and a y-intercept. For example, regression analysis may yield a relationship between price (in some appropriate currency) and number of units sold. The y-intercept represents a maximum price beyond which no units are sold, while the slope reflects the rate-of-change at which the number of sold units increases as price decreases (i.e., in this case there would be a negative slope). A log-linear model can similarly determine the best-fitting exponential model for two such variables.

Once the value drivers have been identified and analyzed, embodiments then allow an advertiser to interact with them. This interaction helps establish an estimated rate card that will give weights to the value drivers that will be most helpful in establishing price points that will help the advertisement product publisher market his inventory.

Each of the constituent parts of a system embodiment may be implemented on any computer system. Such a computing system can include, but is not limited to, desktop PCs, mobile devices such as mobile phones, smartphones, PDAs, portable game consoles and so on, as well as mobile computers such as laptops, notebooks, netbooks, or tablet computers with telecommunications capabilities. Further, a computer system can include, but is not limited to, a portable device having a processor and memory for executing and storing instructions. Software may include one or more applications and an operating system. Hardware may include, but is not limited to, a processor, memory and graphical user interface display. The computing device may also have multiple processors and multiple shared or separate memory components.

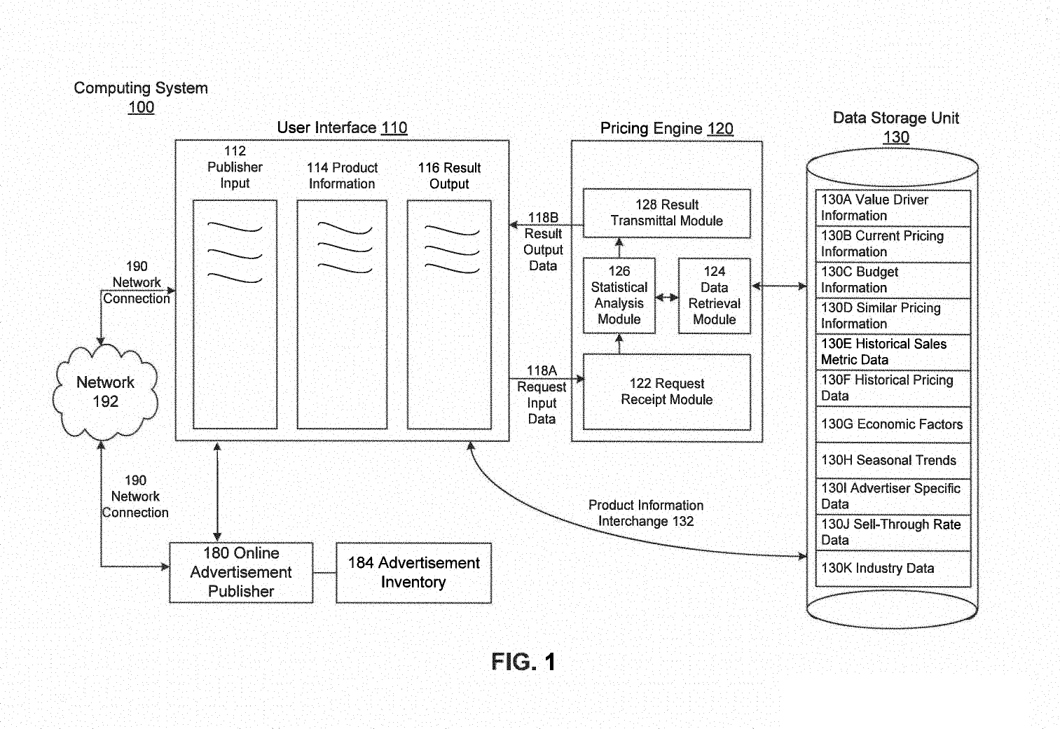

Each of the constituent parts of a system embodiment may be implemented in hardware, software, firmware, or any combination thereof. Likewise, modules or instructions that constitute operative parts of embodiments may utilize any type of structured memory, including a persistent memory. In examples, each data storage infrastructure may be implemented as a relational database. The specific organization of an exemplary computing device is discussed in greater detail below in conjunction with FIG. 1.

FIG. 1 is a diagram illustrating an exemplary system. The diagram illustrates an overall computing system 100. Computing system 100 has three main parts: a user interface 110, a pricing engine 120, and a data storage unit 130.

In FIG. 1, an online advertisement publisher 180 has a set of advertisement inventory 184. Advertisement inventory 184 includes multiple products provided by online advertisement publisher 180. Each product is a specific electronic advertisement product that an advertiser may purchase from online advertisement publisher 180 for use to display his advertisement content. Online advertisement publisher 180 communicates information about advertisement inventory 184 to user interface 110 using input techniques, where the information about advertisement inventory 184 is stored as publisher input 112. User interface 110 may organize and process publisher input 112 as product information 114 that is associated with the set of products. For example, product information 114 might be value drivers such as the size or location of electronic advertisement products, or other value drivers as discussed below. By storing product information 114 at user interface 110, it becomes available for further processing by pricing engine 120 so that computing system 100 can derive results based on analysis of product information 114.

User interface 110 communicates the data from product information 114 to data storage unit 130, where it is associated with other background information. This interchange between user interface 110 and data storage unit is represented as product information interchange 132. Specifically, data storage unit 130 contains several type of data associated with product information 114. Data storage unit 130 stores value driver information 130A, current pricing information 130B, budget information 130C, similar pricing information 130D, historical sales metric data 130E, historical pricing data 130F, economic factors 130G, seasonal trends 130H, advertiser specific data 130I, historical sell-through rate data 130J, and industry data 130K. Data storage unit 130 communicates the data in these subparts of data storage unit 130 to a pricing engine 120, when requested by data retrieval module 124.

More detail will now be provided about the specific types of data provided by and stored in data storage unit 130. Overall, the purpose of data storage unit 130 is to serve as an archive and data repository for several types of information related to product information 114. Such information can be retrieved by data retrieval module 124 at pricing engine 120 for use by statistical analysis module 126 in order to produce outputs, which may be sent by result transmittal module 128 from pricing engine 120 as result output data 118B.

Specifically, example types of information that may be stored in data storage unit 130 are as follows. It may be noted that data storage unit 130 may not store information about all of these and may include additional information based on features included in an implementation.

Value driver information 130A may include information related to value drivers of products. For example, value driver information 130A may include information about factors such as size and placement that can be used to derive valuations for products.

Current pricing information 130B may include information related to current pricing of products. For example, current pricing information 130B may include information such as list prices, minimum prices, maximum prices, and average prices that are associated with specific products.

Budget information 130C may include information about budgeting associated with specific advertisers, as well as how this information may be employed. For example, the budget information may be used in developing strategies for specific advertisers, so that their strategies are in harmony with their budgets.

Similar pricing information 130D may include information about pricing for similar products and/or advertisers. For example, it may store information similar to that stored in current pricing information 130B in terms of what is included, but it may also include additional information about similarities between groups of products and/or advertisers that facilitate use of the information to provide suggestions of similar products and/or advertisers.

Historical sales metric data 130E may include information about statistics related to historical sales. While sales metrics are discussed in greater depth below, historical sales metric data 130E may include various pieces of information about how well various products from a given publisher have sold in the past. Likewise, historical pricing data 130F includes information about historical pricing. However, unlike historical sales metric data 130E which includes statistics that describe sales performance, historical pricing data 130F includes information about how products were priced in the past. In this respect, it includes information similar to that contained in current pricing information 130B, except that it represents past sales rather than recent sales.

Economic factors 130G, seasonal trends 130H, and industry data 130K are categories of general information that may be desirable to factor into various calculations. For example, economic factors 130G might include information such as that it is a recession and it may be desirable to offer discounts. Seasonal trends 130H may include information that it is between Black Friday and Christmas and hence products may be more valuable. Industry data 130K may reflect that there is a great deal of competition to advertise netbooks with banner ads and hence such products may be more valuable.

Advertiser specific data 130I refers to a wide range of information that is stored at data storage unit 130 that interrelates product information 114 with specific advertisers. For example, advertiser specific data 130I may store information about which specific products were purchased by which specific advertisers.

Finally, historical sell-through rate data 130J may be data that is indicative of demand for a section of inventory, wherein sell-through rate is a metric of what proportion of available products from advertisement inventory 184 were actually sold.

Pricing engine 120 has several subparts. As will be discussed below, online advertisement publisher 180 may interact with user interface 110 to request various sorts of information by sending a request for information that may be accompanied by publisher input 112, where publisher input 112 may help fulfill the request for information. Request receipt module 122 receives the request for analysis from user interface 110 as request input data 118A. Request input data 118A includes information from publisher input 112 and product information 114 so that pricing engine 120 has access to basic information to fulfill the request. Pricing engine 120, in turn, causes data retrieval module 124 to retrieve information relevant to product information 114 from data storage unit 130. Data retrieval module 124 transmits the retrieved information related to product information 114 into statistical analysis module 126, which processes the data from data retrieval module 124 and determines appropriate results. It then conveys the result to the result transmittal module 128, which provides result output data 118B that it sends to result output 116 at the user interface 110 to provide online advertisement publisher 180 with results.

Computing system 100 may use network connection 190 to provide the computing device with access to a network 192, such as the Internet. Network 192 may involve wired connections, wireless connections, or any combination thereof. In general, computing system 100 may communicate with a user, such as online advertisement publisher 180, either directly or over network 192, via network connection 190.

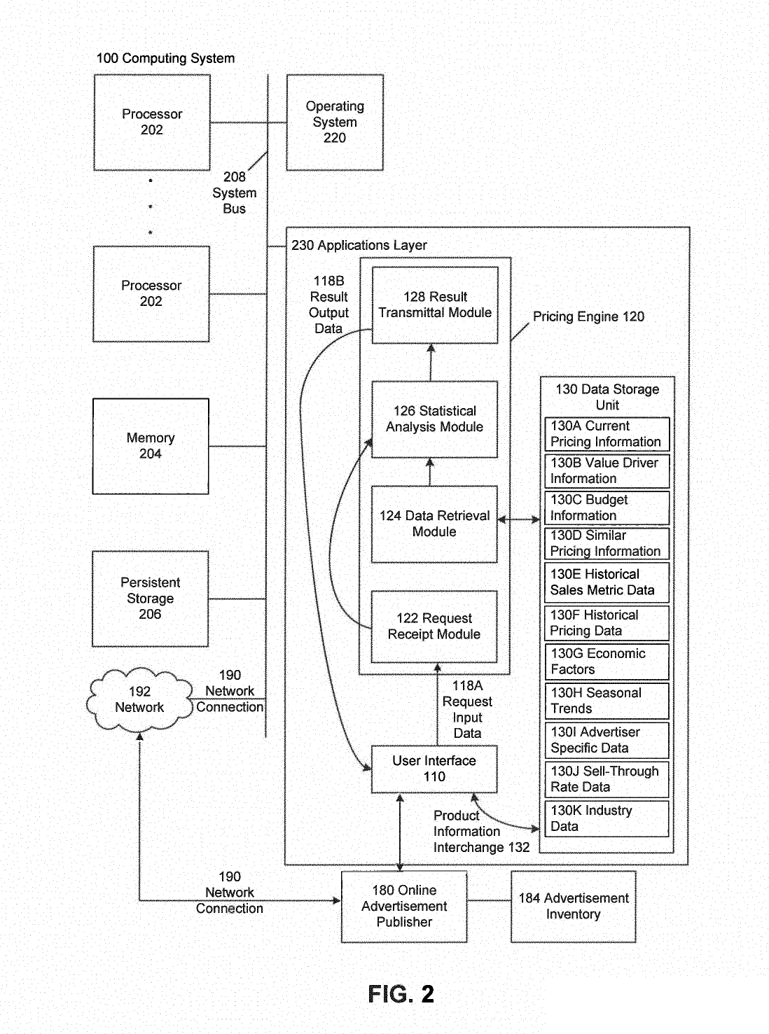

FIG. 2 is another diagram of an exemplary system. FIG. 2 is a diagram illustrating computing system 100 that accesses a network 192 over a network connection 190 that provides computing system 100 with telecommunications capabilities. Computing system 100 uses an operating system 220 as software that manages hardware resources and coordinates the interface between hardware and software.

In an implementation, computing system 100 contains a combination of hardware, software, and firmware constituent parts that allow it to run an applications layer 230. Computing system 100 in embodiments may be organized around a system bus 208, but any type of infrastructure that allows the hardware infrastructure elements of computing system 100 to communicate with and interact with each other may also be used.

Processing tasks in the embodiment of FIG. 2 are carried out by one or more processors 202. However, it should be noted that any type of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof.

In order to manipulate data in accordance with embodiments describe herein, processors 202 access a memory 204 via system bus 208. For data that needs to be stored more permanently, processors 202 access persistent storage 206 via system bus 208. Processors 202, memory 204 and persistent storage 206 cooperate with operating system 220 to provide basic functionality for computing system 100. Operating system 220 provides support functionality for applications layer 230.

FIG. 2 also illustrates a number of components previously portrayed in FIG. 1 and their relationship to the rest of the system. At a high level, FIG. 2 illustrates the relationship between user interface 110, pricing engine 120, and data storage unit 130, such as product information interchange 132 between user interface 110 and data storage unit 130. More specifically, FIG. 2 illustrates online advertisement publisher 180, advertisement inventory 184, request receipt module 122, data retrieval module 124, statistical analysis module 126, result transmittal module 128, request input data 118A and result output data 118B, data storage unit 130, value driver information 130A, current pricing information 130B, budget information 130C, similar pricing information 130D, historical sales metric data 130E, historical pricing data 130F, economic factors 130G, seasonal trends 130H, advertiser specific data 130I, historical sell-through rate data 130J, and industry data 130K. These components all operate as discussed in FIG. 1 and are included here to aid in visualizing the connections between parts of an exemplary embodiment.

Also, FIG. 2 portrays how online advertisement publisher 180 may communicate with computing system 100 either via a direct connection or mediated by network connection 190 and network 192.

1. Providing Pricing Recommendations

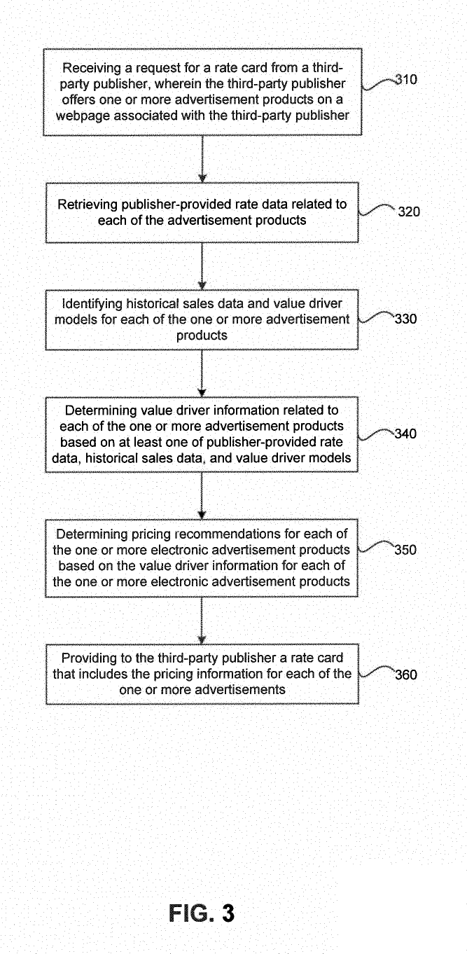

FIG. 3 is a flowchart of an example method.

In stage 310, a request is received for a rate card from a third-party publisher, wherein the third-party publisher offers one or more electronic advertisement products on a webpage associated with the third-party publisher. Stage 310 may occur, for example, between user interface 110 and online advertisement publisher 180, who provides product information 114 as publisher input 112, such that pricing engine 120 is able to process this information when receiving the request.

In response to receiving a request for the rate card in stage 310, certain embodiments may perform stages 320-360.

In stage 320, publisher-provided rate data related to each of the electronic advertisement products is retrieved. Stage 320 may occur, for example, between data retrieval module 124 and data storage unit 130. Product information 114 will have been identified and transmitted from user interface 110 as request input data 118A. Product information 114 may be received by request receipt module 122.

After stage 320, the publisher may also provide budget information that may be used to help determine pricing recommendations. This optional stage may involve information provided by online advertisement publisher 180 as publisher input 112 or alternatively may occur between data retrieval module 124 and budget information 130C in data storage unit 130 based on product information interchange 132 that mines data storage unit 130 given publisher input 112.

Additionally, after stage 320, the publisher may also provide publisher information that may be used to help determine pricing recommendations. The publisher information may relate to value drivers relevant to a specific publisher. This optional stage may involve information provided by online advertisement publisher 180 as publisher input 112 or alternatively may occur may occur between data retrieval module 124 and value driver information 130A in data storage unit 130 based on product information interchange 132 that mines data storage unit 130 given publisher input 112.

Additionally, after stage 320, the method may also provide sell-through rate information that may be used to help determine pricing recommendations. The historical sell-through rate information may include information about what proportion of advertising products are actually sold. This optional stage may occur between data retrieval module 124 and historical sales metric data 130E or sell-through rate data 130J in data storage unit 130 based on product information interchange 132 that mines data storage unit 130 given publisher input 112.

Additionally, after stage 320, the publisher may also provide publisher information, sell-through rate information, and overlap information that may be used to help determine floor pricing recommendations. The overlap information may include information about how different sets of products relate to each other. This optional stage may involve information provided by online advertisement publisher 180 as publisher input 112 or may occur between data retrieval module 124 and value driver information 130A, similar pricing information 130D, or historical sales metric data 130E in data storage unit 130 based on product information interchange 132 that mines data storage unit 130 given publisher input 112.

Additionally, after stage 320, the publisher may also provide pricing information for electronic advertisement products with shared value drivers with each of the one or more electronic advertisement products that may be used to help determine pricing recommendations. The shared value driver information may include information about how different sets of products relate to each other. This optional stage may occur between data retrieval module 124 and value driver information 130A and similar pricing information 130D in data storage unit 130 based on product information interchange 132 that mines data storage unit 130 given publisher input 112.

In stage 330, historical sales data and value driver models are identified for each of the one or more electronic advertisement products. Stage 330 may also occur, for example, between data retrieval module 124 and data storage unit 130. Specifically, value driver information 130A, historical sales metric data 130E, and historical pricing data 130F are example types of information that may be of use in this stage. In general, stage 330 is carried out such that data is available to analyze trends in pricing of the electronic advertisement products. Further, more detailed examples of this data are discussed below. In general, the data may include information about the nature of the products, such as their size and position, as well as characteristics of how well they have sold in the past, such as relationships between pricing and sales.

In stage 340, value driver information related to each of the one or more electronic advertisement products is determined based upon at least one of publisher-provided rate data, historical sales data, and value driver models. Stage 340 may occur, for example, between data retrieval module 124 and statistical analysis module 126. Statistical analysis module 126 will gather the information provided in stage 330 and perform appropriate analysis. Examples of relevant information have been discussed in connection with stage 330. In general, statistical analysis module 126 carries out the statistical analysis of the information using approaches described above, such as regression analysis. For example, it may be able to identify linear or log-linear relationships between various types of data. One such relationship is a demand curve, which explores the relationship between rates and unit sold. More examples of specific types of analysis are provided in the discussion below.

In stage 350, pricing recommendations are determined for each of the one or more electronic advertisement products based on the value driver information for each of the one or more electronic advertisement products. For example, as noted above, statistical analysis module 126 may be able to identify a relationship between the various pieces of data obtained in stage 340. For example, statistical analysis module 126 may be able to give a good approximation of the number of products sold at a given rate. Since revenue may be based on the product of number of products sold and the rate at which each unit is sold, statistical analysis module 126 may be able to recommend a price that will thereby maximize total revenue. While this approach is an example of how pricing recommendations may be derived, it will be noted that other criteria may be used by statistical analysis module 126 as well. For example, pricing recommendations may be derived with goals other than maximizing total revenue, such as maximizing sales of particular products or groups of products that are especially profitable or important.

In stage 360, a rate card is provided to the third-party publisher that includes pricing information for each of the one or more electronic advertisement products. Stage 360 may occur, for example, at result transmittal module 128 and result in output data 118B being sent to result output 116 at user interface 110. It may be noted that stage 360 is an optional stage, and in one embodiment the method may end at stage 350.

It should be noted that with respect to the method of FIG. 3, various embodiments provide for static (Rate Card) analysis and dynamic (Time-of-sale) pricing recommendations. While the overall operation of these various embodiments is quite similar, it should be noted that dynamic pricing includes providing additional information that is only available at point-of-sale. For example, seasonal trends 130H may cause a product to be more valuable during the holiday shopping season than the middle of summer, and which seasonal trend is relevant will only be available at time-of-sale.

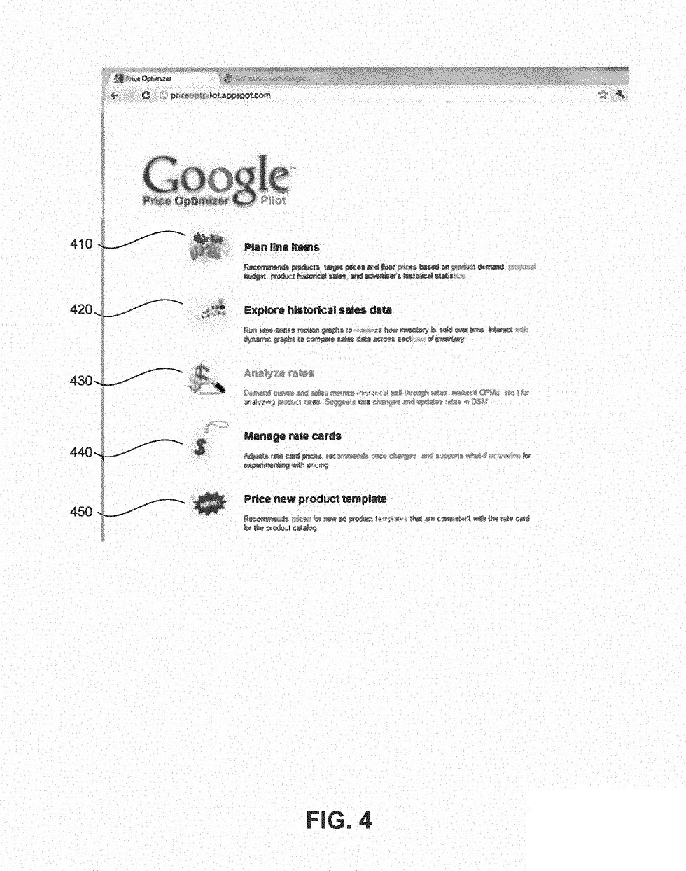

FIG. 4 is a screenshot of an example Price Optimizer Pilot. Note that all of the data which populates the screenshots is demonstration data and should be regarded as exemplary only. The Price Optimizer interface 400 provides a home page for the Price Optimizer Pilot that is the source of screenshots as examples of the operation of embodiments. The Price Optimizer Pilot is designed to help an online advertisement publisher 180 analyze data related to his products to help the publisher make pricing decisions.

For example, the Price Optimizer allows for plan line items 410, which allows online advertisement publisher 180 to plan line items by providing product and pricing recommendations. As provided in the caption, plan line items 410, “Recommends products, target prices and floor prices based on product demand, proposal budget, product historical sales, and advertiser's historical statistics.”

Explore historical sales data 420 allows online advertisement publisher 180 to explore historical sales data to compare representations of the data. As provided in the caption, explore historical sales data 420 allows a user to “Run time-series motion graphs to visualize how inventory is sold over time. Interact with dynamic graphs to compare sales data across sections of inventory.”

Analyze rates 430 allows online advertisement publisher 180 to analyze rates in terms of demand curves and sales metrics. As provided in the caption, analyze rates 430 provides “Demand curves and sales metrics (historical sell-through rates, realized CPMs, etc.) for analyzing product rates. Suggests rate changes and updates rates in DSM.”

Manage rate cards 440 allows online advertisement publisher 180 to manage rate cards to experiment with pricing. As provided in the caption, manage rate cards 440 “Adjusts rate card prices, recommends price changes, and supports what-if scenarios for experimenting with pricing.”

Price new product template 450 allows online advertisement publisher 180 to price new products and manipulate templates. As provided in the caption, price new product template 450 “Recommends prices for new ad product templates that are consistent with the rate card for the product catalog.”

Price Optimizer Interface 400 provides a portal from which plan line items 410, explore historical sales data 420, analyze rates 430, manage rate cards 440, and price new product template 450 may be selected for specific uses of a system. These choices will be discussed in greater depth below in terms of their features and implementation.

Two points should be noted with respect to the screenshots. First, integrated into the graphs are many of unique ways to view this type of data, such as zooming in and having data points flash when a common attribute is selected. Second, the screenshots have graphs and tables that are populated with demonstration data, and the data differs based on the value drivers of each online advertisement publisher 180.

2. Product Suggestions For Publishers

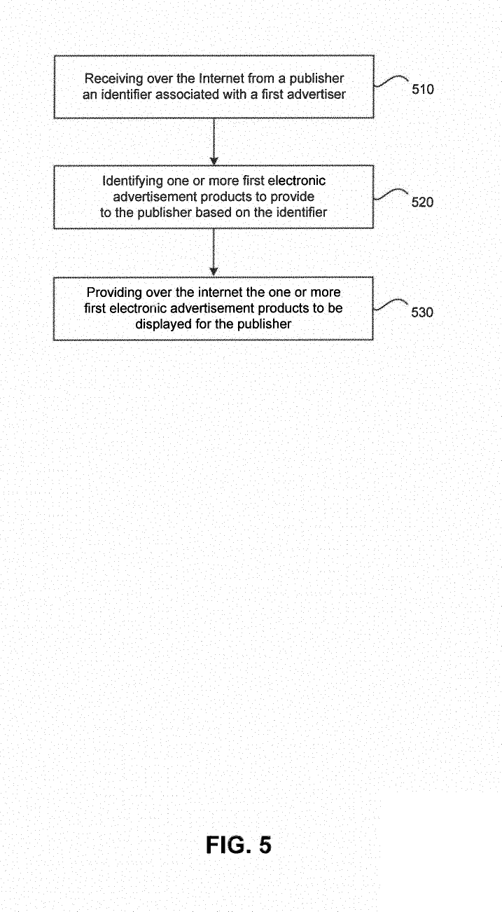

FIG. 5 is a flowchart of an example method. The method of FIG. 5 is a method of providing electronic advertisement products over the Internet. The method of FIG. 5 can be performed by user interface 110, along with pricing engine 120 and data storage unit 130.

In stage 510, an identifier associated with a first advertiser is received over the Internet from a publisher. For example, the publisher may be online advertisement publisher 180. The first advertiser may be one that has previously purchased electronic advertisement products on a webpage associated with the publisher. The publisher can select an advertiser, by name, for example, to view products the advertiser has purchased. The publisher can select an advertiser from a webpage and the information can be transmitted to the pricing engine 120 via user interface 110 so that pricing engine 120 has access to the identifier. For example, the identifier may be provided by online advertisement publisher 180 as publisher input 112 at user interface 110.

In stage 520, one or more first electronic advertisement products are identified to be provided to the publisher based on the identifier. In one implementation, the products may be ones previously purchased by the first advertiser. For example, by stage 520, pricing engine 120 has received a selection of the first advertiser as request input data 118A from user interface 110. Pricing engine 120 can use data retrieval module 124 to access data storage unit 130 to establish information about the first advertiser. For example, data retrieval module 124 may access information related to the first advertiser at advertiser specific data 130I.

In one implementation, a second advertiser is identified that has previously purchased electronic advertisement products from the publisher. For example, the second advertiser may be an advertiser that is different from the one that the publisher indicated. A determination can be made that one of the previously purchased electronic advertisement products by the second advertiser is the same as an electronic advertisement product the first advertiser purchased. This determination may be made by retrieving information related to the second advertiser at advertiser specific data 130I and comparing the information related to each of the advertisers at pricing engine 120, such as at statistical analysis module 126. Alternatively, such information about similar advertisers may be stored as similar pricing information 130D. This analysis may identify that the two advertisers purchased the same electronic advertisement product from the publisher. Then one or more second electronic advertisement products purchased by the second advertiser are identified. Again, such information may be obtained, for example, at advertiser specific data 130I or potentially similar pricing information 130D. Additionally, the one or more second electronic advertisement products may be provided, over the Internet to be displayed for the publisher. A publisher may find the set of electronic advertisement products purchased by the second advertiser useful because it was established that the second advertiser's purchases have at least some overlap with those of the first advertiser. Hence, products purchased by the second advertiser are likely to be relevant suggestions for a publisher.

In one implementation, a second advertiser that has previously purchased electronic advertisement products from the publisher is identified, and a determination is made that at least one of the previously purchased electronic advertisement products is related to an electronic advertisement product the first advertiser purchased. One or more second electronic advertisement products purchased by the second advertiser from the publisher can be identified. Additionally, the one or more second electronic advertisement products may be provided, over the Internet to be displayed for the publisher. This information is likely to be of use to the publisher for a similar rationale to the case where the second advertiser has purchased the same product as the first advertiser, in that the second advertiser is likely to have similar purchasing priorities that are relevant to the publisher.

A related product is one that is in a similar ad space as another product. One product may be a superset, or a subset of another product. For example, a run of site product can include sections such as sports, business, travel, and news on a publisher's webpage. Therefore the product run of site is a superset that includes the sports section.

A related product may also be one that is similar in physical overlap or one where two advertisers can have overlap in the products themselves. For example, soccer moms may be interested in content on TV programming or articles on cleaning products. The audience is the same. Therefore, a publisher may want to get suggestions on what to sell to an advertiser. For example, similarity between advertisers, similarity between attributes of products, similar content categories, as well as audience overlaps between two products may cause them to be considered similar.

In stage 530, the one or more first electronic advertisement products are provided over the Internet to be displayed for the publisher. The publisher is shown the list of products purchased. This list may have been gathered into result output 116 at user interface 110. For example, the providing of the products over the Internet may employ network connection 190 and network 1922 (which may be the Internet).

3. Similar Advertiser Suggestion to Publisher

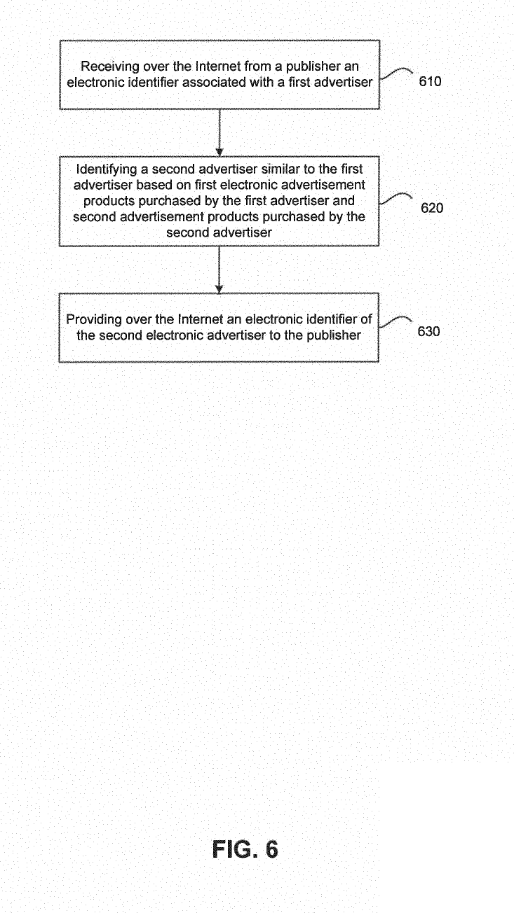

FIG. 6 is a flowchart of an example method. The method of FIG. 6 can be performed by user interface 110, along with pricing engine 120 and data storage unit 130.

In stage 610 an electronic identifier associated with a first advertiser is received over the Internet, from a publisher, wherein the first advertiser is one that has previously purchased first electronic advertisement products from the publisher. For example, the publisher may be online advertisement publisher 180. A publisher can provide an identification associated with an advertiser to get product information related to that advertiser. The identifier will generally be received by user interface 110, which will transmit the identifier to pricing engine 120. The identifier may be received as publisher input 112. Pricing engine 120 can then use data retrieval module 124 to obtain information about the identified advertiser from data storage unit 130 at advertiser specific data 130I. As noted, it is required that the identified advertiser will have already purchased first electronic advertisement products from the publisher. If the identified advertiser does not satisfy this criterion, user interface 110 will return an error message to online advertisement publisher 180 as result output 116.

In stage 620, a second advertiser is identified that is similar to the first advertiser based on the first electronic advertisement products purchased by the first advertiser and second electronic advertisement products purchased by the second advertiser. The second advertiser may be identified as follows. Based on the identity of the first advertiser, as established in stage 610, data retrieval module 124 can access advertiser specific data 130I and establish first electronic advertisement product purchased by the second advertiser. Statistical analysis module 126 may work together with data retrieval module 124 at pricing engine 120 to process advertiser specific data 130I at data storage unit 130 to identify a second advertiser with similar purchases. For example, the second advertiser may be considered similar based on a certain number or proportion of identical or related purchases. Additional relevant information may also be available at similar pricing information 130D. Alternate criteria are discussed below as well.

A publisher may find the identity of the second advertiser useful because the method establishes that the second advertiser's purchases have at least some overlap and/or similarity with those of the first advertiser, who is known to have purchased from the publisher in the past. Hence, the second advertiser is likely to be a relevant potential customer for the publisher.

In one implementation, a determination can be made that at least one of the first electronic advertisement products is the same one of the second electronic advertisement products, as described above. This determination may occur, for example, at statistical analysis module 126 as it processes information retrieved by data retrieval module 124 from advertiser specific data 130I at data storage unit 130.

in one implementation, a determination can be made that at least one of the previously purchased first electronic advertisement products is related to one of the second electronic advertisement products, as described above. This determination may occur, for example, at statistical analysis module 126 as it processes information retrieved by data retrieval module 124 from advertiser specific data 130I at data storage unit 130.

In one implementation, a plurality of advertisers are identified that are similar to the first advertiser based on first electronic advertisements products purchased by the first advertiser and respective second electronic advertisement products purchased by each of the plurality of second advertisers. For each of the plurality of second advertisers, a determination is made of a number of second electronic advertisement products that are related to any of the first electronic advertisement products. The plurality of second advertisers can be ranked based on number of second electronic advertisement products that are related to any of the first electronic advertisement products. Again, this determination may occur, for example, at statistical analysis module 126 as it processes information retrieved by data retrieval module 124 from advertiser specific data 130I at data storage unit 130. Statistical analysis module 126 may additionally be capable of performing the ranking task. The ranking task can be performed simply by identifying numbers of related products, by comparing each set of second electronic advertisement products to the set of first electronic advertisement products to obtain counts of related products, and then performing a sort.

In one implementation, a list of first electronic advertisement products the first advertiser purchased from the publisher can be provided to the publisher, as well as a list of second electronic advertisement products the second advertiser purchased from the publisher. Such a list may be generated by statistical analysis module 126 at pricing engine 120 by compiling the results of the other stages and may be provided to online advertisement publisher 180 via user interface 110 and result transmittal module 128 as result output 116.

In stage 630, an electronic identifier of the second advertiser is provided over the Internet to the publisher. For example, it could be a name of the second advertiser, or a webpage associated with the advertiser, or a unique identifier associated with the second advertiser. This result may be provided as result output 116 to online advertisement publisher 180. For example, the providing of the result over the Internet may employ network connection 190 and network 192 (which may be the Internet).

4. Product Information of Publisher's Product

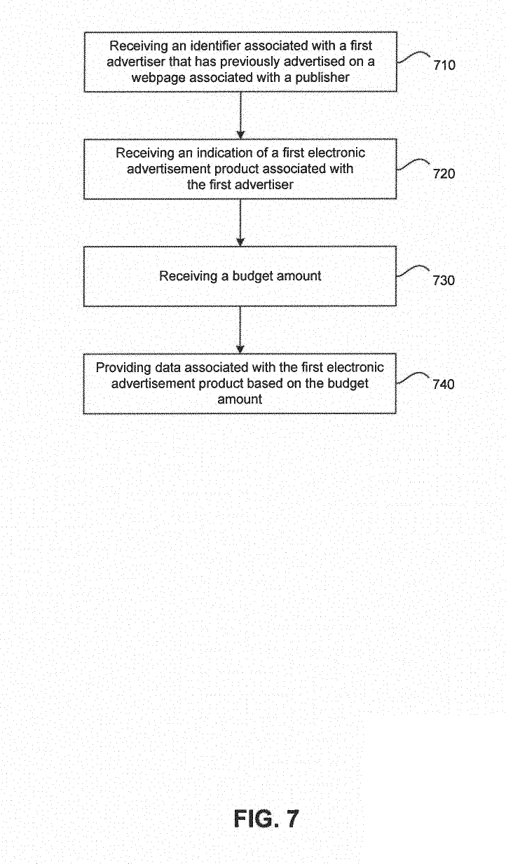

FIG. 7 is a flowchart of an example method. The method of FIG. 7 can be performed by user interface 110, along with pricing engine 120 and data storage unit 130.

In stage 710, an identifier associated with a first advertiser, who has previously advertised on a webpage associated with a publisher, is received. For example, the publisher may be online advertisement publisher 180. A publisher can provide an identification associated with an advertiser to get product information related to that advertiser. The identifier will generally be received by user interface 110 as publisher input 112, which will transmit the identifier to pricing engine 120. Pricing engine 120 can then use data retrieval module 124 to obtain information about the identified advertiser from data storage unit 130 at advertiser specific data 130I. As noted, it is required that the identified advertiser will have already purchased first electronic advertisement products from the publisher. If the identified advertiser does not satisfy this criterion, user interface 110 will return an error message to online advertisement publisher 180 as result output 116.

In stage 720, an indication of a first electronic advertisement product associated with the first advertiser is received. For example, online advertisement publisher 180 may specify a product via user interface 110 as publisher input 112. Additionally, user interface 110 may access product information 114 related to the selected product and employ pricing engine 120 to use data retrieval module 124 in order to access advertiser specific data 130I at data storage unit 130 to determine the relationship between the first advertiser and the selected product.

In stage 730, a budget amount is received for electronic advertisement products from the publisher. The budget can be received from the publisher, for example, via user interface 110 as further publisher input 112.

In stage 740, data associated with the first electronic advertisement product based on the budget amount is provided, wherein the data includes at least one of a list price that indicates a current rate associated with the first electronic advertisement product, a target price that indicates a desired price that is calculated to be appropriate for the first electronic advertisement product based on the budget, and a floor price that indicates a minimum price that is calculated to be appropriate for the first electronic advertisement product based on the budget. For example, the budget received in stage 730 may be processed at pricing engine 120 at statistical analysis module 126. As part of processing the budgeting, statistical analysis module 126 may use data retrieval module 124 to retrieve information from data storage unit 130. For example, data retrieval module 124 may retrieve information from current pricing information 130B, budget information 130C, similar pricing information 130D, historical pricing data 130F, and advertiser specific data 130I as potentially relevant information that is incorporated into setting product information 114 as result output 116 associated with the selected product.

In one implementation, the list price can be received from the publisher. For example, online advertisement publisher 180 may set a list price as publisher input 112 via user interface 110 in product information 114, which may in turn be passed through pricing engine 120 to be stored in data storage unit 130 at current pricing information 130B or passed directly to data storage unit 130 via product information interchange 132.

In one implementation, the target price can be calculated. The target price can be calculated based on at least one of the budget, the first advertiser, a number of transactions between the first advertiser and the publisher, other advertisers that can purchase the first electronic advertisement product, a season of the year, an availability of impressions for the first electronic advertisement product, wherein the availability of impressions indicates an amount of availability of the first electronic advertisement product, a historical sell-through rate, a future sell-through rate, a prediction of an inventory at which the first electronic advertisement product will sell out, a list price, and a probability of selling the inventor at a higher price. The target price can be calculated to maximize revenue for the publisher. For example, pricing engine 120 may use the information just discussed (which may be obtained from various subsystems of data storage unit 130, as well as product information 114 and from online advertisement publisher 180 as publisher input 112 via user interface 110) at statistical analysis module 126 to establish the target price, which may be stored at result output 116.

In one implementation, the floor price can be calculated based on the budget, overlapping products that share impressions, a sell-through rate, a season, a discounting threshold, and an advertiser tier.

For example, a sports section product may be part of a run of site product. If an advertiser books run of site they can also show in sports too. Therefore, run of site ends up being cheap but both pull from sports impressions, assuming sports has higher demand.

For example, pricing engine 120 may use the information just discussed (which may be obtained from various subsystems of data storage unit 130, as well as product information 114 and publisher input 112 from online advertisement publisher 180) at statistical analysis module 126 to establish the floor price, which may be stored at result output 116.

In one implementation, product advertiser history associated with the first electronic advertisement product can be provided to the publisher. The product advertiser history can indicate at least one of a minimum price associated with the first electronic advertisement product paid by the first advertiser, a maximum price associated with the first electronic advertisement product paid by the first advertiser, an average price associated with the first electronic advertisement product paid by the first advertiser, an average number of units purchased by the first advertiser, and an average discount percentage given to the first advertiser. For example, this historical data may be obtained by data retrieval module 124 from subsystems of data storage unit 130 such as historical sales metric data 130E, historical pricing data 130F, and advertiser specific data 130I. Statistical analysis module 126 can organize the information, and result transmittal module 128 can send it to user interface 110 as result output data 118B, to be shared with online advertisement publisher 180 as result output 116.

In one implementation, product history information associated with the first electronic advertisement product can be provided. The product history information can indicate at least one of the one or more second advertisers that have purchased the first electronic advertisement product, a minimum price paid by any advertiser for the first electronic advertisement product, and a maximum price paid by any advertiser for the first electronic advertisement product. For example, this historical data may be obtained by data retrieval module 124 from subsystems of data storage unit 130 such as historical sales metric data 130E, historical pricing data 130F, and advertiser specific data 130I. Statistical analysis module 126 can organize the information, and result transmittal module 128 can send it to user interface 110 as result output data 118B, to be shared with online advertisement publisher 180 as result output 116.

In one implementation, a list of electronic advertisement products and their rates associated with the first advertiser that are similar to the first electronic advertisement product can be provided to the publisher. For example, the list may be obtained by data retrieval module 124 from data storage unit 130 at advertiser specific data 130I and provided to online advertisement publisher 180 via user interface 110 as result output 116.

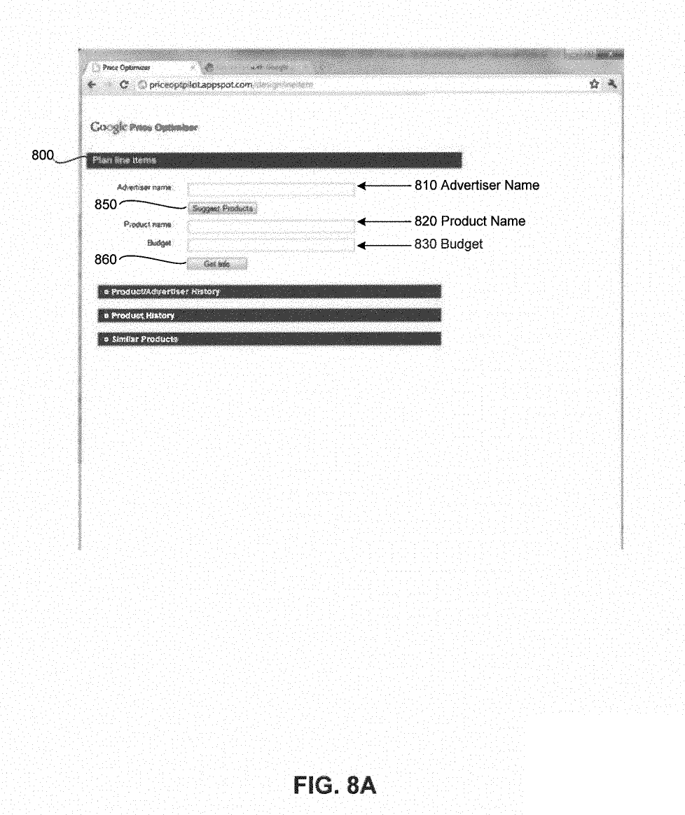

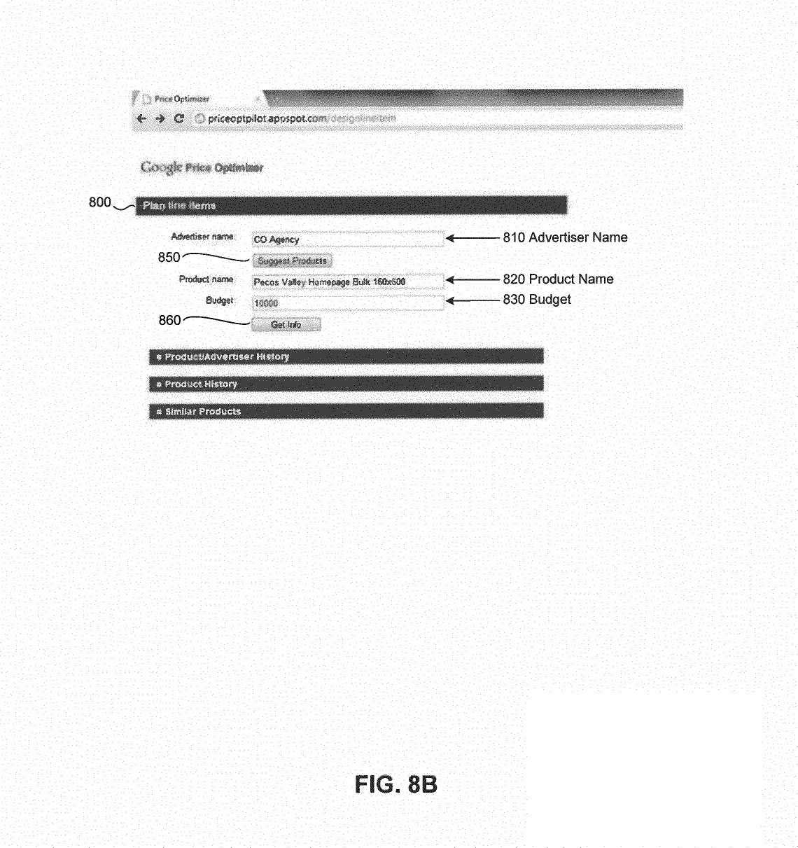

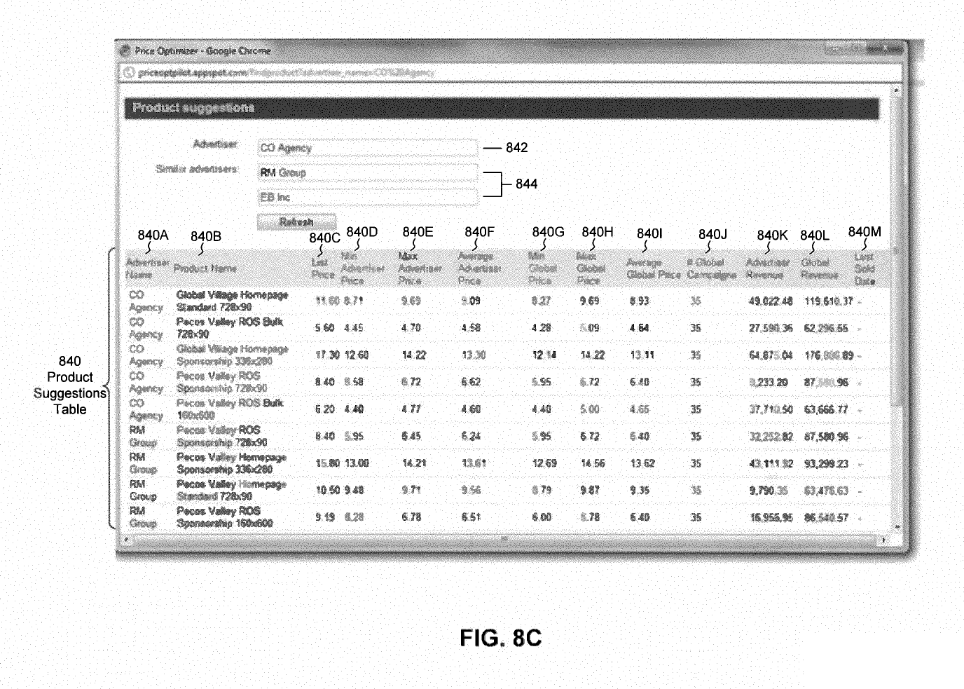

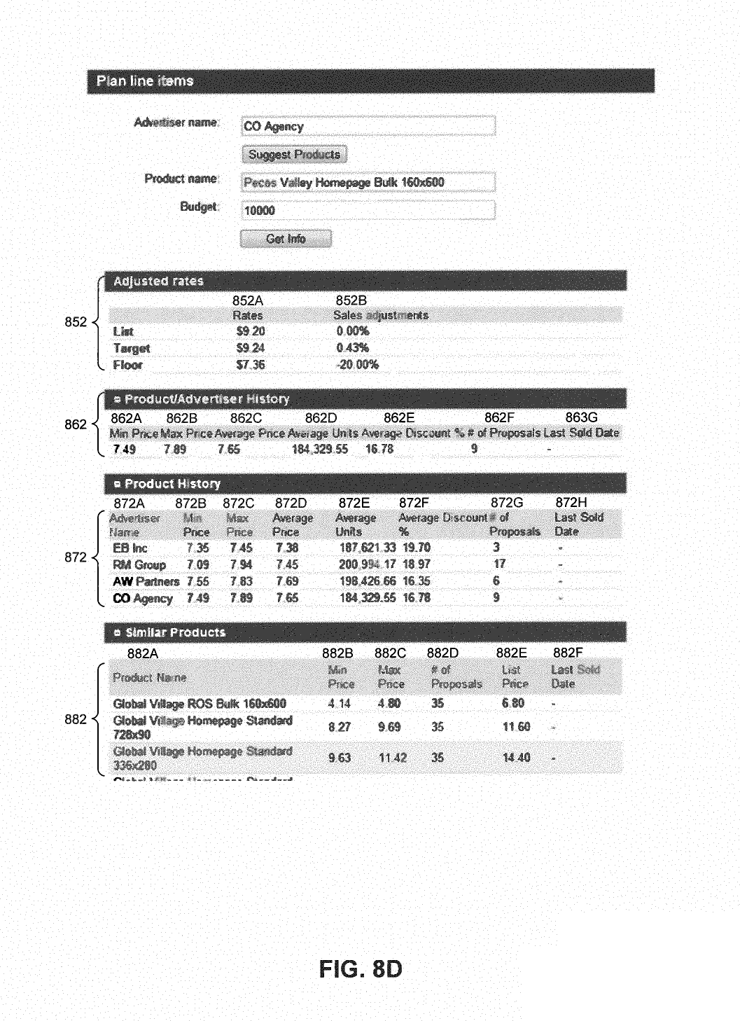

The operation of the methods of FIGS. 5-7 is illustrated by example in FIGS. 8A-D.

FIGS. 8A-D are screenshots of Plan Line Items, according to an embodiment. Plan line items is accessed from Price Optimizer Interface 400 as a link, plan line items 410. Plan line items 410 is associated with the operations of the methods portrayed in FIGS. 5-7.

FIG. 8A shows a screenshot of Plan Line Items which is ready for input. The plan line items window 800 allows online advertisement publisher 180 to input advertiser name 810, product name 820, and/or budget 830 information, and then look up planning information corresponding to that line item. The planning information may include access to product/adviser history, product history, and similar products, as will be discussed below. In general, plan line items window 800 is presented by user interface 110 to online advertisement publisher 180. Online advertisement publisher 180 provides the above information (advertiser name 810, product name 820, and/or budget 830 information) as publisher input 112, and user interface 110 transmits this information to pricing engine 120 as request input data 118A, which may receive the information, for example, at request receipt module 122. Additionally, there are several buttons that online advertisement publisher 180 can use to obtain information based on line items. For example, “Suggest Products” button 850 is a button that will provide a set of suggestions, an example of which is shown in FIG. 8C.

FIG. 8B shows a screenshot of Plan Line Items, which has been populated with the information for a specific product. In this embodiment, online advertisement publisher 180 has entered “CO Agency” as advertiser name 810, “Pecos Valley Homepage Bulk 160×600” as product name 820, and “10000” as budget 830. As noted, the information in FIG. 8B is intended Only as an example. It may also be noted that it is possible to obtain some Plan Line Items results while only entering data for some data fields, and leaving others blank. For example, it may be possible to activate the “Suggest Products” button 850 after only entering advertiser name 810 without entering product name 820 or budget 830. That is, the results of FIG. 8C may be available simply by entering “CO Agency” as advertiser name 810 and then activating the “Suggest Products” button 850, even if the product name 820 and budget 830 are left blank.

FIG. 8C shows a screenshot of a table of product suggestions 840 for a given advertiser. It is retrieved by pressing the “Suggest Products” button 850 after entering the specific advertiser name 810 from FIGS. 8A-B. In this case, the specific advertiser is “CO Agency.” The product suggestions table 840 includes a variety of information related to the advertiser name 810. The information in product suggestions table 840 includes advertiser name 840A, product name 840B, list price 840C, minimum advertiser price 840D, maximum advertiser price 840E, average advertiser price 840F, minimum global price 840G, maximum global price 840H, average global price 840I, number of global campaigns 840J, advertiser revenue 840K, global revenue 840L, and last sold date 840M.

The information presented in FIG. 8C, along with that presented in FIG. 8D, includes results of performing the methods of FIGS. 5-7 discussed above.

The contents and derivation of the information in FIG. 8C will now be discussed in greater detail. As can be seen, FIG. 8C identifies an advertiser 842, which is selected by online advertisement publisher 180. In this example, advertiser 842 is “CO Agency.” FIG. 8C also presents similar advertisers 844, which are “RM Group” and “EB Inc” in this example. These similar advertisers are identified by using the method described with respect to FIG. 6. The execution of this method and potential variants are discussed above. However, to reiterate, this method generally begins with the selected advertiser and then provides suggestions of similar advertisers such that similar advertisers are suggested who have a purchasing history that is similar to that of the selected advertiser.

The main table, product suggestions table 840, provides information related to the method described with respect to FIG. 5. The table contains suggested products, as well as a considerable number of statistics and metrics, that characterize the history and pricing of the suggested products. The execution of this method and potential variants are discussed above. However, to reiterate, this method identifies potential products that may be of interest with respect to an identified advertiser. As can be seen in advertiser name, 840A, some of the suggested products are products from “CO Agency” itself, and others are suggested products from “RM Group,” which is considered a similar advertiser. As noted, one embodiment only provides suggested products for the selected advertiser, while another embodiment will include suggested products for related advertisers.

Product name 840B includes information specifying the name of a particular product. For example, “Global Village Homepage Standard 728×90” identifies a particular type of advertisement product for sale on a particular page. As can be seen, FIG. 8C includes a wide variety of product suggestions. The choice of which products to suggest is discussed above in connection with FIG. 5.

Product suggestions table 840 also includes a wide variety of additional information about the suggested products. For example, this information may include list price 840C, minimum advertiser price 840D, maximum advertiser price 840E, average advertiser price 840F, minimum global price 840G, maximum global price 840H, average global price 840I, number of global campaigns 840J, advertiser revenue 840K, global revenue 840L, and last sold date 840M. In general, these pieces of information represent statistics about each suggested product that may be referenced and interpreted by an online advertisement publisher 180 to determine strategies with respect to an individual suggested product. In general, this additional information is generated by pricing engine 120, which incorporates product information 114 via request receipt module 122 and information form data storage unit 130 via data retrieval module 124. The information is processed at statistical analysis module 126 and sent to result transmittal module 128, which generates results such as product suggestions table as result output data 118B, providing result output 116 via user interface 110 to online advertisement publisher 180.

Thus, if the user inputs appropriate identifying information into Plan Line Items, embodiments can generate a product suggestions table 840 with a comprehensive set of pricing analysis and recommendations.

If online advertisement publisher 180 activates get info button 860 (along with product name 820 and budget 830), the user is provided with a series of analysis tables, presented in FIG. 8D. These results are also representative of various results of the methods of FIGS. 5-7.

The first table is the adjusted rates table 852. It provides list, target, floor rates 852A, and sales adjustments 852B. For example, list, target, and floor rates 852A may be generated as part of the operation of the method of FIG. 7. Sales adjustments 852B reflect the relationship between a given rate and the list rate. In the example, sales adjustments indicate that there is no adjustment between the list rate and itself, but there is a 0.43% increase between the list rate and the target rate, and a −20.00% decrease between the list rate and the floor rate. This information is obtained, as discussed above, by calculations that are performed by statistical analysis module 126 in pricing engine 120, based on information obtained from user interface 110 via request receipt module 122 and from data storage unit 130 via data retrieval module 124. For example, the list price may incorporate information from current pricing information 130B (or it may be set by online advertisement publisher 180), the target price may incorporate information from budget information 130C (as well as the budget which may be set by online advertisement publisher 180), and the floor price may incorporate information from budget information 130C, similar pricing information 130D, sell-through rate data 130J, etc. It is to be noted that these are simply example sources of information, and any other source of information available to an embodiment may help provide data for adjusted rates table 852.

The second table is the product/advertiser history table 862. This table includes additional information that may be generated as part of the operation of the method of FIG. 7. It includes information about minimum price 862A, maximum price 862B, average price 862C, average units 862D, average discount percentage 862E, number of proposals 862F, and last sold date 862G, for the current product. Similarly, this information is obtained, as discussed above, by calculations that are performed by statistical analysis module 126 in pricing engine 120, based on information obtained from user interface 110 via request receipt module 122 and from data storage unit 130 via data retrieval module 124. Since these statistics are intended to reflect historical pricing, data retrieval module 124 may access historical sales metric data 130E, as well as historical pricing data 130F, as part of generating these statistics.

The third table is the product history table 872. Product history table 872 differs from product/advertiser history table 862 in that it allows comparison of how a given product is performing between different advertisers, whereas product/advertiser history table 862 is designed to provide insight into how the product is performing for a specific selected advertiser. It includes information about each advertiser name 872A, minimum price 872B, maximum price 872C, average price 872D, average units 872E, average discount percentage 872F, number of proposals 872G and last sold date 872H. Similarly, this information is obtained, as discussed above, by calculations that are performed by statistical analysis module 126 in pricing engine 120, based on information obtained from user interface 110 via request receipt module 122 and from data storage unit 130 via data retrieval module 124. This information is obtained, as discussed above, by calculations that are performed by statistical analysis module 126 in pricing engine 120, based on information obtained from user interface 110 via request receipt module 122 and from data storage unit 130 via data retrieval module. Since these statistics are intended to reflect historical statistics for a variety of advertisers, data retrieval module 124 may access historical sales metric data 130E, as well as historical pricing data 130F, as part of generating these statistics but may also incorporate information from similar pricing information 130D, advertiser specific data 130I, industry data 130K, etc.

Finally, the fourth table is the similar products table 882. In general, this table presents results that online advertisement publisher 180 may want to be aware of to compare the current product with similar products (for the same advertiser). It includes information about the product name 882A, minimum price 882B, maximum price 882C, number of proposals 882D, list price 882E, and last sold date 882F. The information related to similar products may be generated in conjunction with the methods of both FIG. 5 and FIG. 7. Similarly, this information is obtained, as discussed above, by calculations that are performed by statistical analysis module 126 in pricing engine 120, based on information obtained from user interface 110 via request receipt module 122 and from data storage unit 130 via data retrieval module 124. The types of data from data storage unit 130 that are retrieved are similar to those used in product/advertiser history table 862 to generate statistics for the current product, except that these statistics are generated for similar products. The manner in which similar products are identified is discussed in connection with the method of FIG. 5, above.

Thus, it can be clearly seen that Plan Line Items 800 provides a user with comprehensive dynamic price optimization information.

5. Discount Analyzer

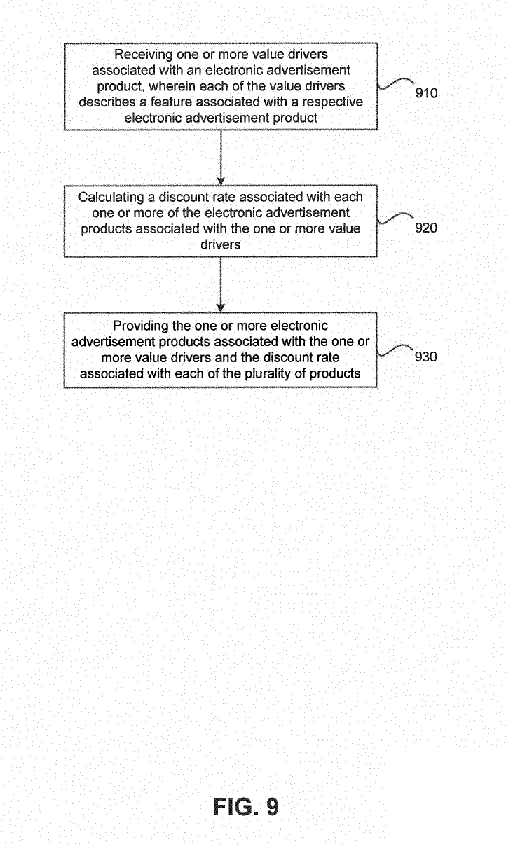

FIG. 9 is a flowchart of an example method. The method of FIG. 9 can be performed by user interface 110, along with pricing engine 120 and data storage unit 130.

In stage 910, one or more value drivers associated with an electronic advertisement product are received. Each of the value drivers describes a feature associated with a respective electronic advertisement product. As discussed previously, the characteristics of the products and packages that actually have a measurable influence on price are called value drivers. Aspects of value drivers have been discussed previously, and this discussion will not be repeated herein. However, from the perspective of implementing stage 920, value drivers are received that may be factored into a discount analysis. This value driver information may include a combination of input from online advertisement publisher 180 as publisher input 112, which is received at user interface 110, as well as a collection of various preexisting information from data storage unit 130 by data retrieval module 124 at pricing engine 120, such as from value driver information 130A at data storage unit 130. Specific types of value driver information and how they are gathered and used in the context of discount analysis will be discussed below and examples of use will be provided.

In stage 920, a discount rate associated with each one or more electronic advertisement products associated with the one or more value drivers is calculated. The discount rate is a difference between a price the publisher had set to sell each electronic advertisement product at and an actual price at which the respective electronic advertisement product is sold. Effectively, a discount rate may be viewed as a realization rate, which reflects the proportion of the desired price of an advertisement product that a publisher was able to actually obtain or realize. A discount rate may be characterized in several ways. For example, the discount rate may reflect the proportion of the desired price that was realized, or it may reflect an absolute amount of discount. It will be recognized that several metrics for discount rate exist that characterize the relationship between targeted and actual prices, some of which are relative and some of which are absolute.

For example, the calculations involved in determining the discount rate may occur at statistical analysis module 126 within pricing engine 120. The inputs that are necessary, which are the set price and the actual price, may be procured by pricing engine 120 for statistical analysis module 126 by procuring the set price, such as from online advertisement publisher 180, or via data retrieval module 124 from current pricing information 130B within data storage unit 130.

In stage 930, the one or more electronic advertisement products associated with the one or more value drivers and the discount rate associated with each of the plurality of products are provided to the publisher. In general, stage 930 is carried out by user interface 110, which provides information to online advertisement publisher 180 as result output 116 that it receives via result transmittal module 128 from pricing engine 120.

In one implementation, a graph of the discount rate associated with each of the plurality of electronic advertisement products is provided to the publisher. Such a graph may have additional added features. For example, the graph may include functionality to select one or more of the electronic advertisement products. As another potential feature of the graph, one of the axes of the graph represents a discount amount and a second axis represents a revenue amount generated from the electronic advertisement products. The graph includes functionality to select one or more sales persons associated with selling each of the electronic advertisement products. For example, statistical analysis module 126, as discussed above, may calculate discount rate information related to sales persons by incorporating information from data storage unit 130, such as advertiser specific data 130I by data retrieval module 124. Result transmittal module 128 may transmit this information to user interface 110, which may in turn produce a graph of the information to provide the results to online advertisement publisher 180. User interface 110 may generate the graph from result output data 118B provided by result transmittal module 128 as result output 116.

In one implementation, a selection of an electronic advertisement product is received, and a graph with only the electronic advertisement product and a discount associated with the selected electronic advertisement product is provided to the publisher. This implementation uses the feature of graphing discount rate that was just discussed, but user interface 110 receives publisher input 112 from online advertisement publisher 180 to allow selection of a single product, such that the graph only displays a graph of that specific product's discount rate.

In one implementation, a selection of one of the sales persons is received, and a graph with electronic advertisement product and a discount associated with the selected sales person is provided. For example, information about sales persons may be retrieved by data retrieval module 124 from data storage unit 130, such as at advertiser specific data 130I, and it may be factored into the processing of the discounting by statistical analysis module 126 before the graph is generated as result output 116 at user interface 110.

In one implementation, a rate type is received. The rate type is one of a CPM (Cost per million), CPC (Cost per click), or CPD (Cost per day).

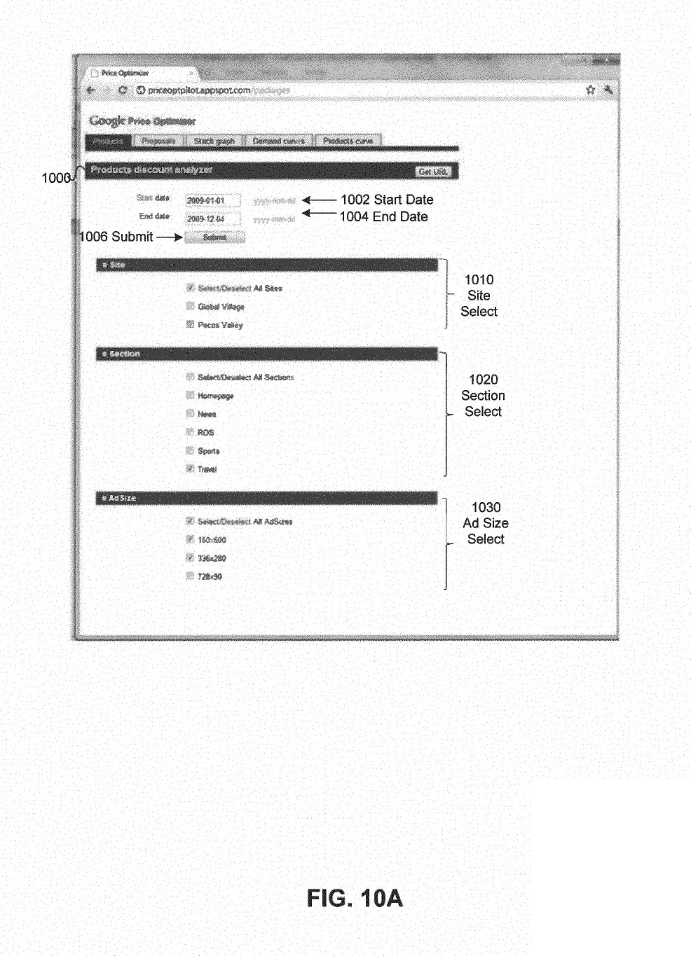

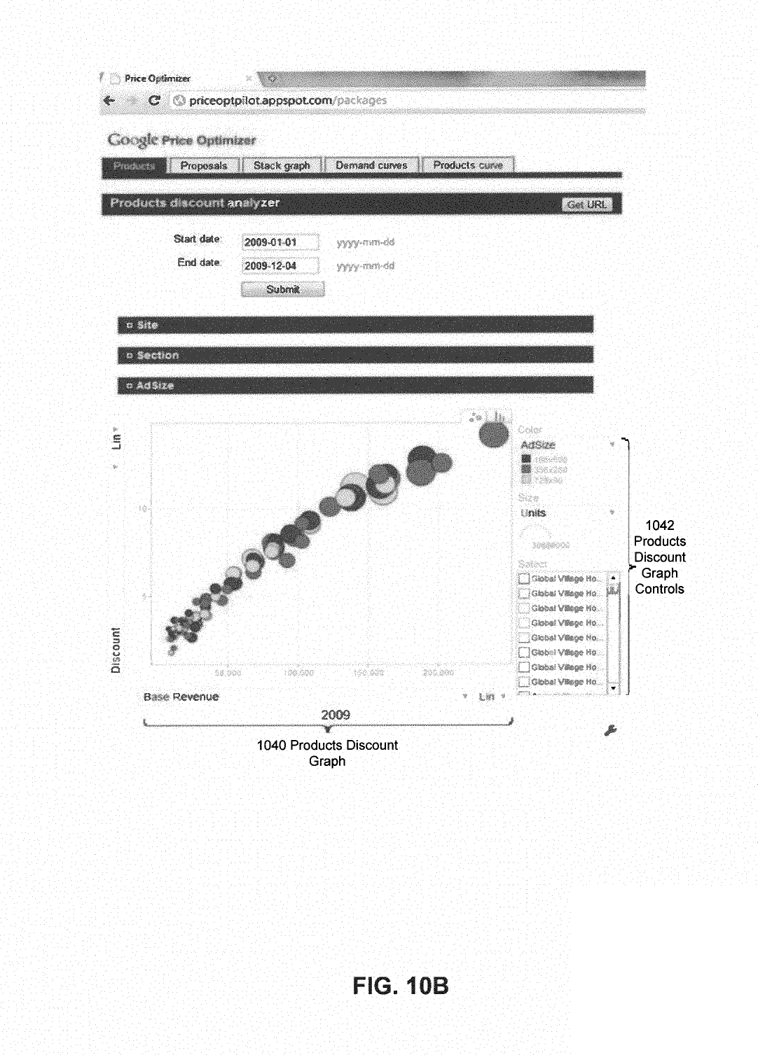

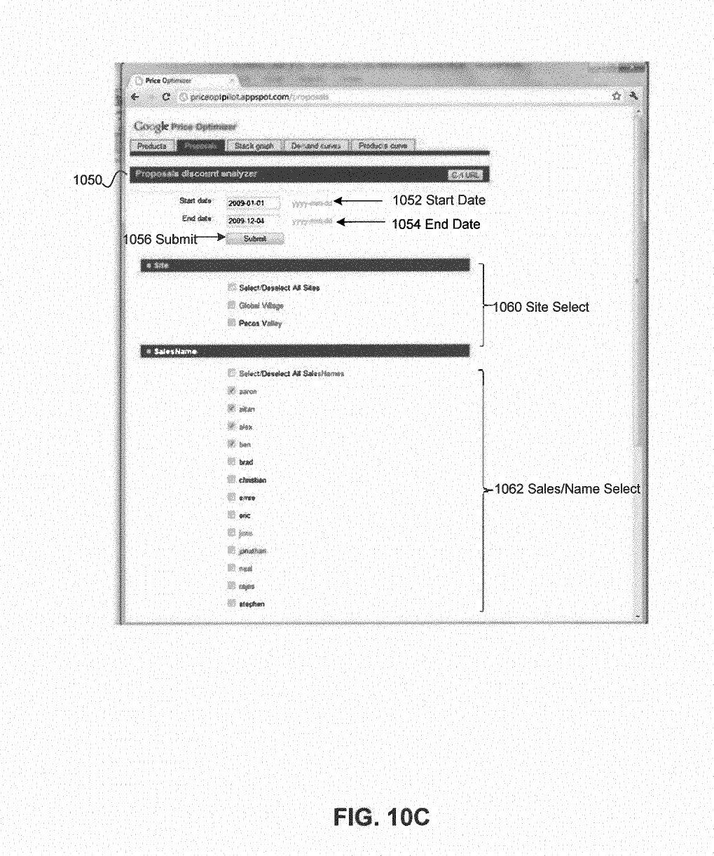

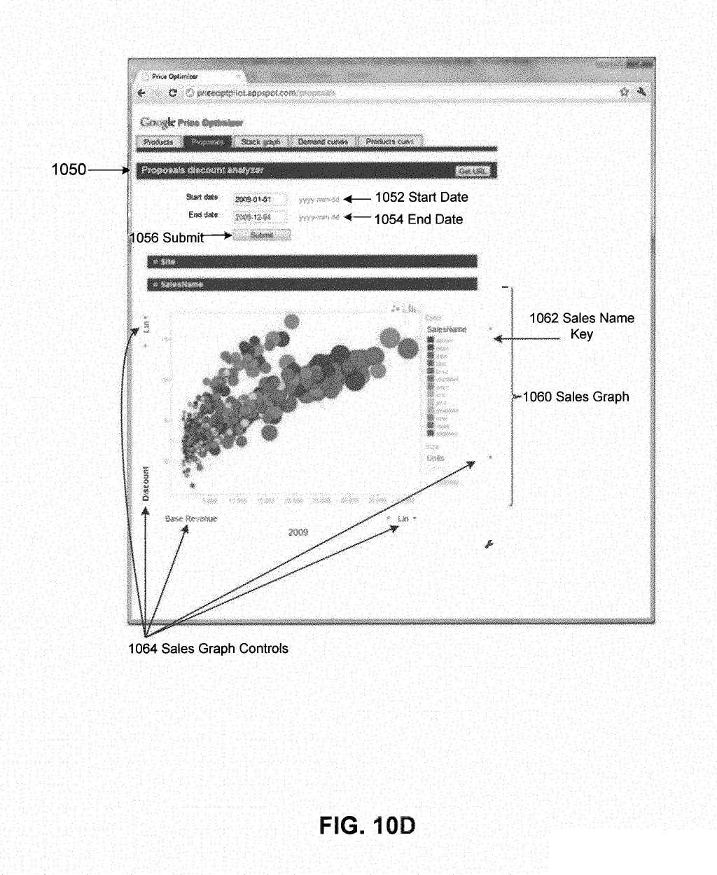

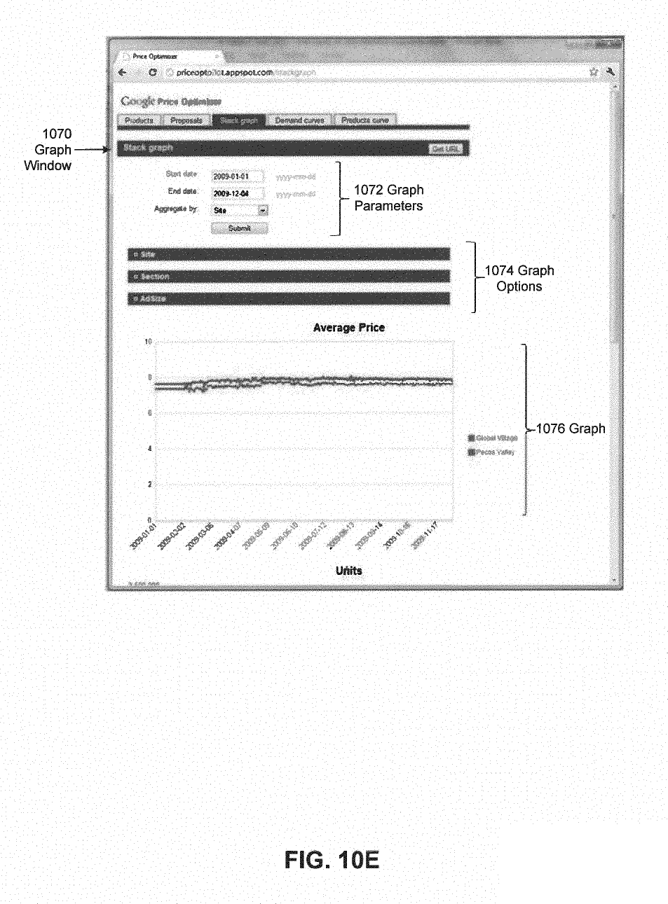

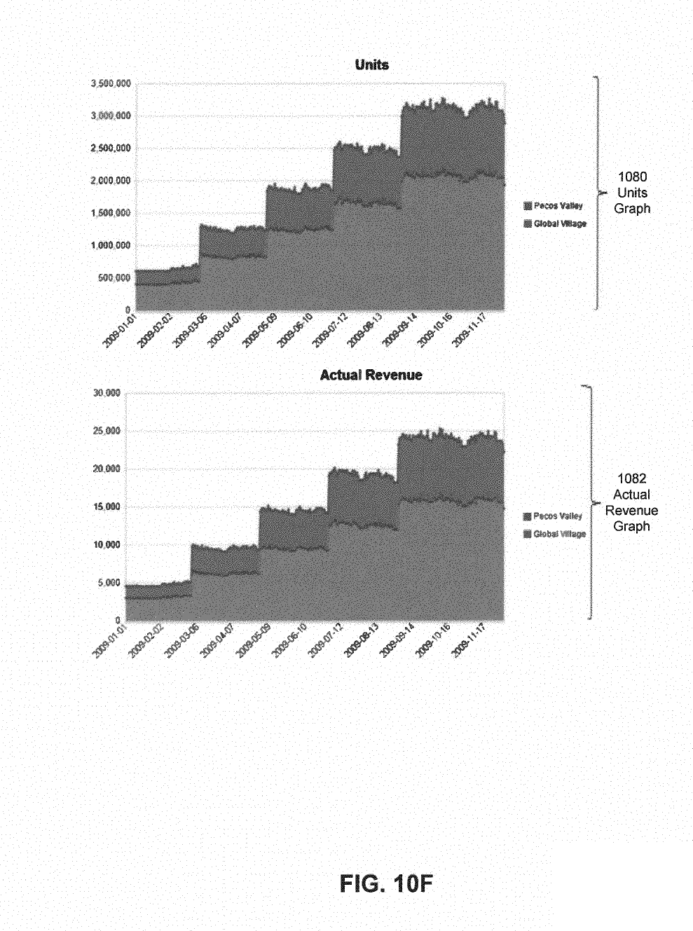

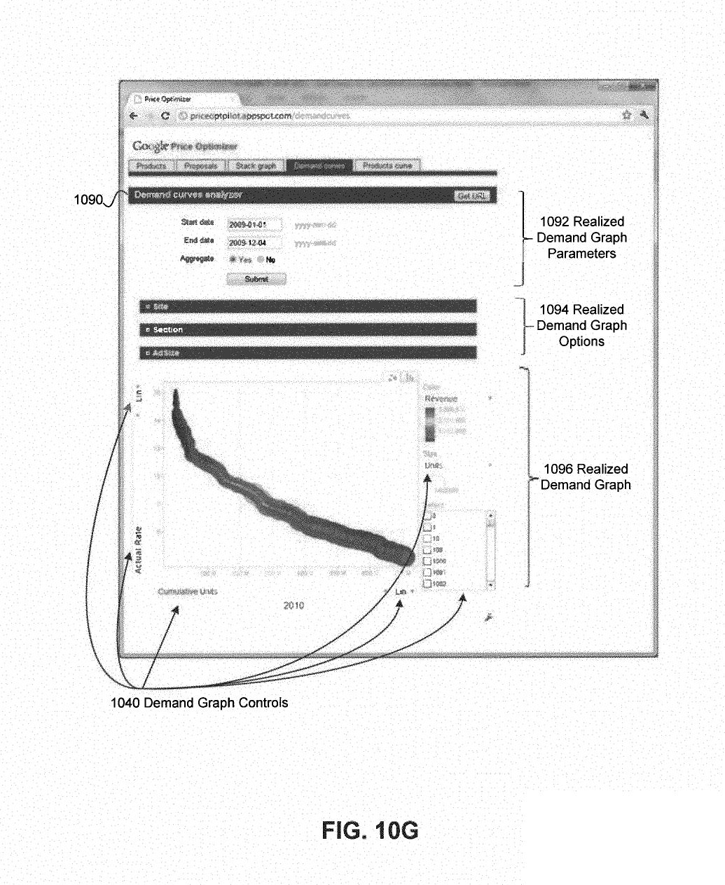

FIGS. 10A-G are screenshots of an example Products Discount Analyzer. The example Products Discount Analyzer shows a scenario in which the method of FIG. 9 may be carried out. However, it should be noted that this scenario is only an example and other embodiments may operate in different ways.

FIG. 10A is a screenshot that shows the products discount analyzer window 1000. This window may be accessed from price optimizer interface 400 by selecting explore historical sales data 420.

The products discount analyzer window 1000 allows online advertisement publisher 180 to analyze discounting information for products over a date range, starting with start date 1002 and ending with end date 1004. This example allows online advertisement publisher 180 to enter start date 1002 and end date 1004 textually into fields. However, as noted, other ways may allow online advertisement publisher 180 to specify the date range. In general, user interface 110 presents products discount analyzer window 1000 to online advertisement publisher 180, who sets the date range.

Furthermore, products discount analyzer window 1000 allows online advertisement publisher 180 to control which aspects of the inventory of online advertisement publisher 180 are analyzed by using checkboxes. For example, there are groups of checkboxes including site select checkboxes 1010, section select checkboxes 1020, and ad size select checkboxes 1030. Additionally, one of the checkboxes in each group provides a way to select/deselect all checkboxes within that group with one selection.

While FIG. 10A allows online advertisement publisher 180 to make selections about how the discount analysis occurs by selecting checkboxes within groups, it will be readily recognized that other graphical and textual interfaces (or even other interfaces, such as a voice interface) may be incorporated into user interface 110 so as to allow online advertisement publisher 180 to control how the discount analysis is carried out.

Once the selections have been made, the products discount analyzer produces a products discount graph 1040 (as shown in FIG. 10B) that can be manipulated with products discount graph controls 1050. It may be noted that in FIG. 10B, the parts of FIG. 10A that were expanded to allow control over what is analyzed (site select checkboxes 1010, section select checkboxes 1020, and ad size select checkboxes 1030) have been collapsed to provide easier review of the graph. For example, FIG. 10B provides a variety of information in graphical form. It displays a plot of several circles representing discounts for various products. Each circle is plotted to reflect the base revenue associated with a product versus the amount of discount, wherein the discount rate is a difference between a price the publisher had set to sell each electronic advertisement product at and an actual price at which the respective electronic advertisement product is sold. It can be seen based on the graph of FIG. 10B that a useful trend emerges, that in general as base revenue increases, so too discount increases in a linear fashion. As discussed previously, producing the graph of FIG. 10B may incorporate the use of statistical analysis module 126 to calculate discount rate information based on information retrieved from data storage unit 130, such as using historical sales metric data 130E or historical pricing data 130F by data retrieval module. Rate result transmittal module 128 may transmit this information to user interface 110, which may in turn produce a graph of the information to provide the results to online advertisement publisher 180 as result output 116.

FIG. 10C is a screenshot of Proposals Discount Analyzer, according to an embodiment. Rather than analyzing discounts for products, proposals discount analyzer window 1050 is designed to analyze discounts for sales persons. The proposals discount analyzer window 1050 allows online advertisement publisher 180 to analyze discounting information for sales persons over a date range, starting with start date 1052 and ending with end date 1054. Submit button 1056 enters a query into the system as request input data 118A based on publisher input 112. Online advertisement publisher 180 can control which aspects of the inventory of online advertisement publisher 180 are analyzed by using checkboxes group by site select boxes 1060 and sales/name section select 1062. In general, user interface 110 presents proposals discount analyzer window 1050 to online advertisement publisher 180, who sets the date range. The implementation discussion for proposals discount analyzer window 1050 is generally quite similar to that of products discount analyzer window 1000, except that proposals discount analyzer incorporates data from sources such as advertiser specific data 130I that associates sales with individual sales persons.

FIG. 10D is another screenshot of Proposals Discount Analyzer, according to an embodiment. Now, parameters have been entered using checkboxes group by site select boxes 1060 and sales/name section select 1062, and submit button 1056 has activated a visual representation of the sales as sales graph 1060. A key to the items in the sales graph is provided as sales name key 1062. Furthermore, sales graph controls 1064 allow online advertisement publisher 180 to change which factors the graph is based on, such as which variables are displayed, as well as whether the axes of sales graph 1060 are labeled in a linear or logarithmic fashion. In general, the graphs provided by Proposal Discount Analyzer are implemented in a manner that has much in common with the graphs provided by products discount analyzer (i.e., the graph of FIG. 10B), except that the data plotted may differ.

FIG. 10E is a screenshot of a line graph provided by Stack Graph, according to an embodiment. Graph window 1070 is controlled by graph parameters 1072 and graph options 1074. These in turn lead to a graph display 1076, which represents changes in price for selected products. When displaying a graph, the user selects parameters that specify the products to consider, and the graph represents changes in average prices over time. In general, setting the parameters for the Graph of FIG. 10E will occur through interaction between online advertisement publisher 180 and user interface 110, as discussed above, by providing publisher input 112, and the information to graph will be produced by interaction between statistical analysis module 126 and data retrieval module 124 at pricing engine 120, such that statistical analysis module 126 uses data retrieval module 124 to retrieve information such as historical sales metric data 130E and historical pricing data 130F from data storage unit 130. The information to graph is passed to user interface 110 as result output data 118B by result transmittal module 128, and user interface 110 graphs the information as result output 116.

FIG. 10F is a screenshot of additional graphs produced by Stack Graph, according to an embodiment. FIG. 10F shows a Units Graph Display 1080, as well as an Actual Revenue Graph 1082. Units Graph Display 1080 portrays numbers of products sold over time. As can be seen in the example, the products sold over time may be broken down by site (i.e., Pecos Valley and Global Village). Actual revenue graph 1082 portrays revenue over time. Actual revenue graph 1082 also portrays results that may be broken down by site (i.e., Pecos Valley and Global Village). These graphs are produced in a similar manner to those above, in that statistical analysis module 126 at pricing engine 120 gathers the information to be graphed based on statistical analysis of information provided as request input data 118A and associated information from data storage unit 130, gathered by data retrieval module 124. The information is packaged by result transmittal module 128, sent to user interface 110 as result output data 118B, and graphed by user interface 110 as result output 116 for online advertisement publisher 180.

FIG. 10G is a screenshot of Demand Curves Analyzer, according to an embodiment. Demand curve analyzer window 1090 is controlled by realized demand graph parameters 1092 and realized demand graph options 1094. These in turn lead to a realized demand graph display 1096, which represents changes in price for selected products. For example, realized demand graph display 1096 could display data points that represent cumulative units versus actual rate. In the example, it can be seen that the rate begins high, and cumulative units increase as rate decreases. However, the rate of increase with respect to cumulative units decreases as rate continues to decrease, such that decreasing rate initially has a large impact on cumulative units, but this impact progressively decreases. Other controls might include a key, or controls that switch between linear and logarithmic views. When displaying a demand curve, the user selects parameters that specify the products to consider, and the demand curve is a plot of points that show units sold versus rate with color coding (not shown) to express revenues. The demand curve provides a graphical representation of a relationship between the value drivers of each of the one or more advertisement products and the historical sales information of each of the one or more advertisement products. Demand curves may be produced in a similar manner to those above, in that statistical analysis module 126 at pricing engine 120 gathers the information to be graphed based on statistical analysis of information provided as request input data 118A and associated information from data storage unit 130, gathered by data retrieval module 124. The information is packaged by result transmittal module 128, sent to user interface 110 as result output data 118B, and graphed by user interface 110 as result output 116 for online advertisement publisher 180.

6. Rate Analyzer

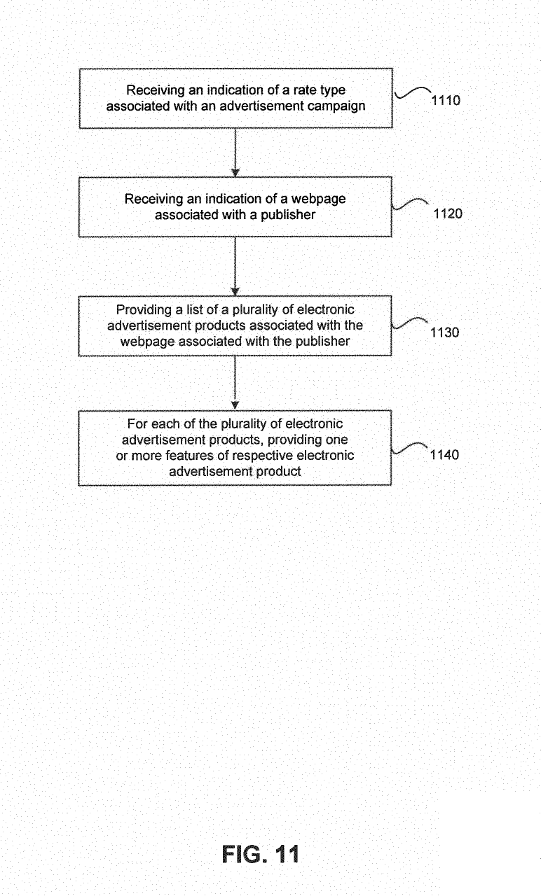

FIG. 11 is a flowchart of an example method. The method of FIG. 11 can be performed by user interface 110, along with pricing engine 120 and data storage unit 130.

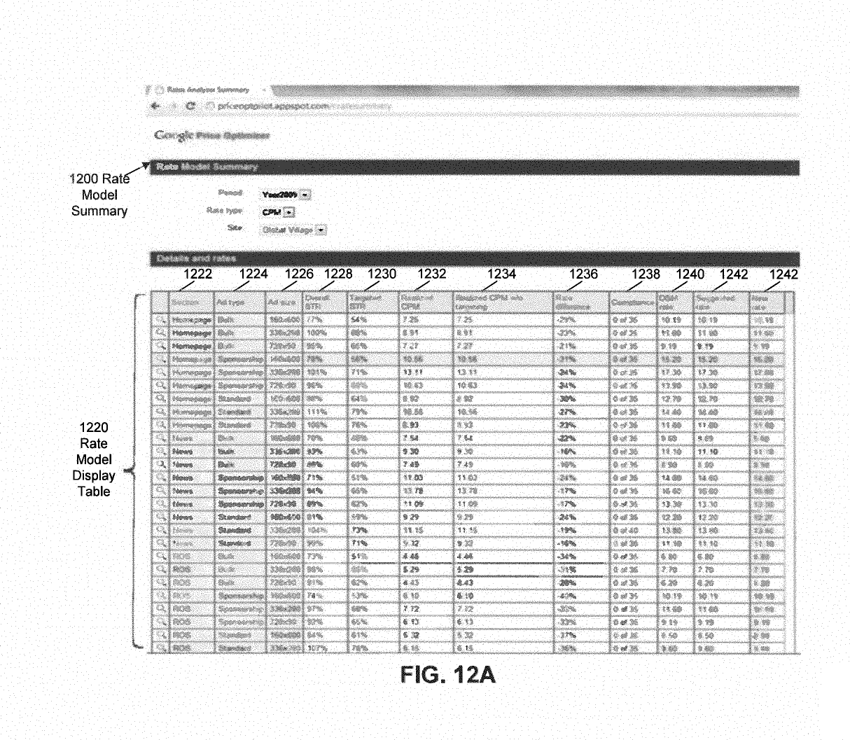

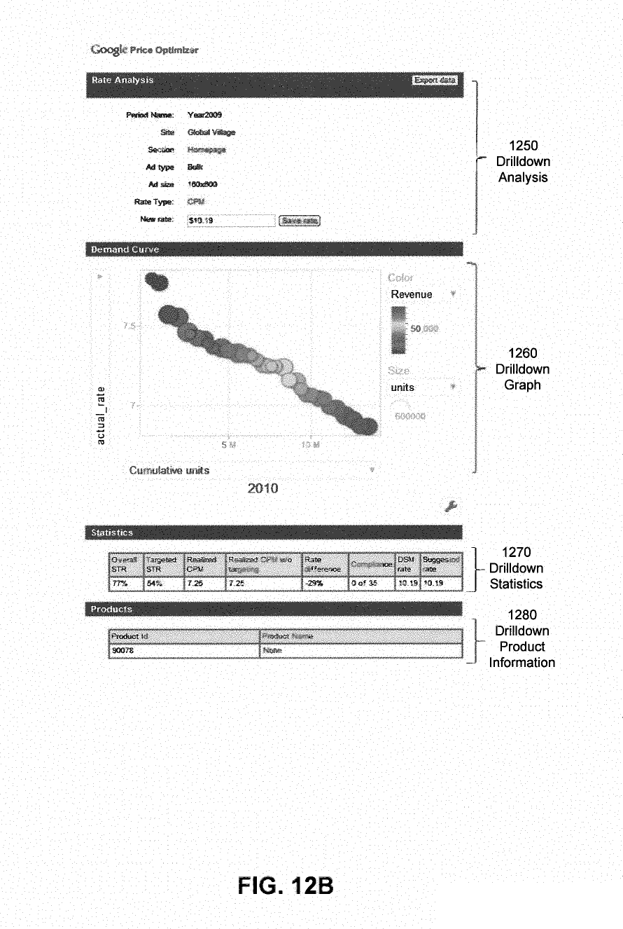

In stage 1110, an indication of a rate type associated with an advertisement campaign is received. For example, the rate type may be a choice between CPM, CPC, or CPD. The rate type indication may be received by user interface 110, establishing publisher input 112 for online advertisement publisher 180. As discussed, the indication may be performed using a variety of textual, graphical, or other forms of user interface 110. For example, the selection may be performed using a drop-down menu selection control, as is provided below in FIG. 12A.

In stage 1120, an indication of a webpage associated with a publisher is received. Again, this selection may be carried out between user interface 110 and online advertisement publisher 180, establishing publisher input 112. In general, it will be necessary to indicate in this stage which site is relevant, as the rate analysis involves analyzing the selected webpage to ascertain which products are provided in association with it, so that details about rates associated with the web site may be compiled. For example, the selection may be performed using a drop-down menu selection control, as is provided below in FIG. 12A, in which the drop-down contains a list of the sites that are available. Such a list may be based on a variety of sources of information, such as advertisement inventory 184, or alternatively by accessing advertiser specific data 130I by data retrieval module 124 at pricing engine 120 or by product information interchange 132.

In stage 1130, a list of a plurality of electronic advertisement products associated with the webpage associated with the publisher is provided. Each of the plurality of electronic advertisement products is available for purchase by an advertiser. Stage 1130 begins with information about the selected webpage, which was identified in stage 1120. User interface 110 includes listings of product information 114. The information may be available from advertisement inventory 184 or may alternatively be available by accessing advertiser specific data 130I by data retrieval module 124 at pricing engine 120 or by product information interchange 132. Based on this information, user interface 110 should be able to generate a list of products related to the selected webpage.

In stage 1140, for each of the plurality of electronic advertisement products, one or more features of respective electronic advertisement product is provided, wherein a feature of an electronic advertisement product is a piece of metadata related to the product, and wherein the features provided are chosen at least partially based on the rate type. The information necessary to carry out this stage is gathered as follows. User interface will have identified a list of products (as discussed above) and associated product information 114. User interface 110 can communicate this information to request receipt module 122 at pricing engine 120 as request input data 118A. Request receipt module 122 passes this information to statistical analysis module 126, which in turn uses data retrieval module 124 to obtain any additional necessary relevant information associated with the products from data storage unit 130. Such information is gathered and organized in statistical analysis module 126, which uses rate result transmittal module 128 to transmit the results as result output data 118B back to user interface 110, which provides the results to online advertisement publisher as result output 116. The statistical analysis generally includes identifying statistics associated with rates for the various products and may draw upon product information 114, as well as information form data storage unit 130, such as value driver information 130A, current pricing information 130B, and other types of information that may be desired by online advertisement publisher 180.

In one implementation, the one or more features include at least one of an advertisement section associated with the respective electronic advertisement product, wherein the advertisement section indicates a section of the webpage that the electronic advertisement product is associated with, an advertisement type associated with the respective electronic advertisement product, an overall sell-through rate associated with the respective electronic advertisement product, a targeted sell-through rate associated with the respective electronic advertisement product, a realized rate associated with the respective electronic advertisement product, a realized rate without targeting associated with the respective electronic advertisement product, a rate difference associated with the respective electronic advertisement product, a compliance associated with the respective electronic advertisement product, a list rate associated with the respective electronic advertisement product, and a suggested rate associated with the respective electronic advertisement product. This information may be gathered from appropriate subsystems of data storage unit 130 by data retrieval module 124 when statistical analysis module 126 is gathering information to be returned as result output data 118B to user interface 110. Additionally, part of the information may be derived from product information 114 and may be passed as request input data 118A to request receipt module 122, which can then transmit it to statistical analysis module 126.

The rate type is one of a CPM, CPC, or CPD. The meaning of these acronyms was discussed earlier. The choice of rate type may make certain features more applicable, and lead to those features being provided by embodiments.

In one implementation, an indication to change the list rate associated with one of the plurality of electronic advertisement products is received, and a different rate to set as the new rate is received from the publisher. Such an indication may be received by user interface 110 as publisher input 112 from online advertisement publisher 180. The indication may be passed from user interface 110 to pricing engine 120 as request input data 118A. For example, user interface 110 may use product information interchange 132 to interface with data storage unit 130 in order to update current pricing information 130B in accordance with the new price.

In one implementation, a model of one or more value drivers can be updated based on the new rate. For example, user interface 110 may use product information interchange 132 to interface with data storage unit 130 in order to update value driver information 130A at data storage unit 130 in accordance with the new rate.

FIGS. 12A-B are screenshots of a Rate Model Summary, according to an embodiment. Rate model summary 1200 controls the rate card displayed at rate model display table 1220 with parameters for the rate model set with rate model parameters 1210. This window may be accessed from price optimizer interface 400 by selecting analyze rates 430.

As discussed previously, the rate card includes information about various aspects of products that factor into their valuation (value drivers) and actual results that demonstrate the actual value of products.

FIG. 12A displays various types of data that may go into a rate card. For example, data in a rate card may include:

1. Section 1222 (i.e., Homepage, New, Sports)

2. Ad type 1224 (i.e., Bulk, Sponsorship, Standard)

3. Ad size 1226 (i.e., 160×600, 336×280, 728×90)

4. Overall STR 1228 (sell-through rate, reflects proportion of inventory sold)

5. Targeted STR 1230 (sell-through rate, reflects proportion of inventory sold with targeting)

6. Realized CPM 1232 (cost per thousand impressions)

7. Realized CPM w/o (without) targeting 1234 (cost per thousand impressions without targeting)

8. Rate difference 1236 (how has the CPM changed based on the targeting)

9. Compliance 1238

10. DSM rate 1240 (reflects rate from DART sales manager, which operate based on bidding models)

11. Suggested rate 1242 (reflects suggested rate from Price Optimizer)

12. New rate 1244 (based on Suggested rate)

Not shown in FIG. 12A, but also displayed on the Rate Model Summary are three control buttons. These buttons allow Exporting a Summary, Exporting a Summary for Period and Rate Type, and saving rates to DSM. The Exported Summaries are stored in a spreadsheet format. In general, the spreadsheet format may be any format that allows the storage of data in tabular form. In general, FIG. 12A illustrates a listing of products for a specific publisher along with a considerable amount of corresponding information that a publisher can use to see how successful a pricing strategy has been, as well as potential strategies for changing pricing. In general, the information provided in FIG. 12A will be gathered for statistical analysis module 126 within pricing engine 120 by data retrieval module 124 from data storage unit 130, packaged by result transmittal module 128, sent as result output data 118B, and provided to online advertisement publisher 180 as result output 116. As discussed previously, a wide range of information is stored in data storage unit 130, and data retrieval module 124 will draw upon data storage unit 130 to obtain relevant information for statistical analysis module 126 so that it is able to produce result output data 118B. It may be noted that FIG. 12A is an example, and online advertisement publisher 180 may provide input to user interface 110 that may include requests to add or omit information from result output data 118B.

FIG. 12B depicts information resulting from drilling-down into information about individual rates. A basic drilldown analysis 1250 provides information about period name, site, section, ad type, ad size, rate type, and new rate, which may be saved. The information from drilldown analysis 1250 may be chosen to uniquely specify an individual product. For example, it may be noted that the first column of each row of rate model display table 1220 in FIG. 12A includes a magnifying glass. Clicking on the magnifying glass selects the product corresponding to that row for drilldown analysis. Of course, it will be recognized that there are many other ways of uniquely identifying a product for drilldown analysis 1250. Second, a drilldown graph 1260 shows information about specific products. For example, drilldown graph 1260 may provide information about the relationship between cumulative units and rate. Drilldown graph 1260 contains similar information to demand graph display 1096 in FIG. 10G, but drilldown graph 1260 is directed to a certain specific product. FIG. 12B also shows drilldown statistics 1270. These statistics include information about overall STR, targeted STR, realized CPM, realized CPM without targeting, rate difference, compliance, DSM rate, and suggested rate (as defined with respect to 12A). However, the statistics are presented only for the selected individual product. Finally, drilldown product information 1280 provides identifying information about a specific product (if available), the information including characteristics such as product ID and product name. As can be seen from the example, such information may not be available for all products. For example, the product portrayed in FIG. 12B does not have a defined name, and hence drilldown product information 1280 indicates that none is available. However, it does have a product ID, so drilldown product information 1280 provides this information.

7. Historical Sell-Through Rates for Publisher Products

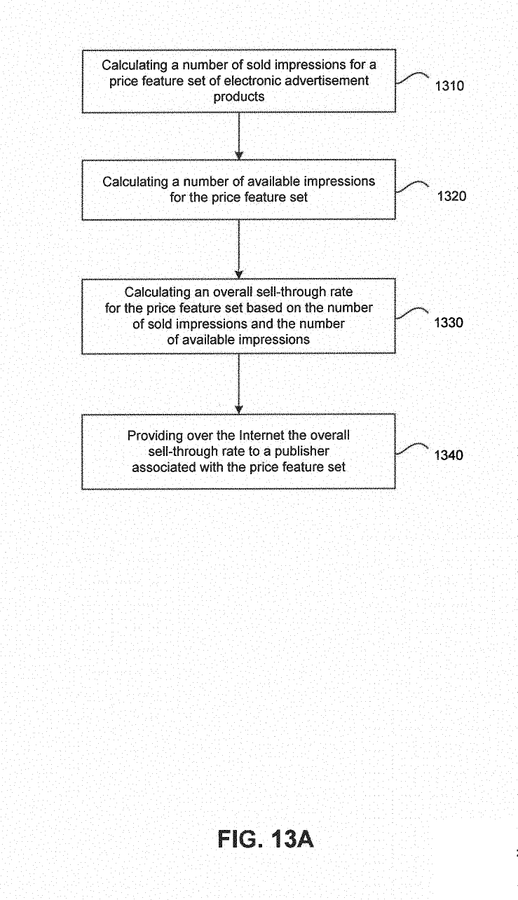

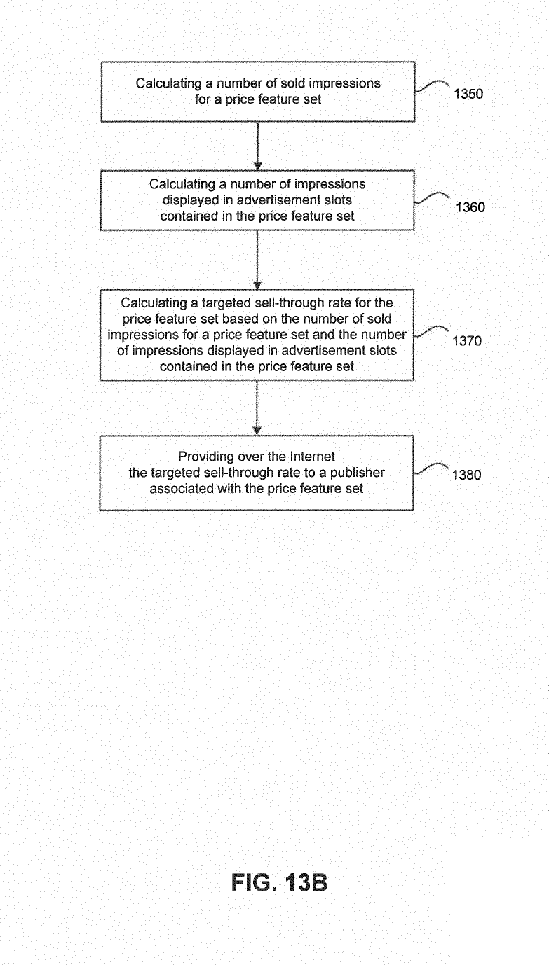

FIG. 13A is a flowchart of an example method. The method of FIG. 13A can be performed by user interface 110, along with pricing engine 120 and data storage unit 130.

In stage 1310, a number of sold impressions for a price feature set of electronic advertisement products can be calculated. A price feature set includes electronic advertisement products that are at least one of a same size, a same section, or a same site. For example, this number of sold impressions may be calculated by statistical analysis module 126, which may use data retrieval module 124 to access information at data storage unit 130, such as historical sales metric data 130E and/or sell-through rate data 130J. For example, the data may reveal the number of sold impressions for each product in the feature set, and the number of sold impressions for the set may be calculated as the sum of the sold impressions for each product.

In stage 1320, a number of available impressions for the price feature set can be calculated. For example, this number of available impressions may be calculated by statistical analysis module 126, which may use data retrieval module 124 to access information at data storage unit 130, such as historical sales metric data 130E and/or sell-through rate data 130J. Alternatively, this information may be available by analyzing product information 114 associated advertisement inventory 184, where such information is stored in association with user interface 110. In general, as in stage 1320, it is necessary to obtain the number of available impressions for each product (i.e., in product information 114, advertisement inventory 184, or a part of data storage unit 300, such as historical sales metric data 130E).

In stage 1330, an overall sell-through rate for the price feature set can be calculated based on the number of sold impressions and the number of available impressions. In one implementation, the number of sold impressions can be divided by the number of available impressions. More information about the information used when deriving these numbers in the overall sell-through rate calculation is discussed below. For example, this calculation may be performed by statistical analysis module 126 at pricing engine 120. It may also be desirable to incorporate information from sell-through rate data 130J and/or to record the results at sell-through rate data 130J for future reference.

The overall sell-through rate is the percentage of premium impressions that were sold. This number is calculated by dividing the number of guaranteed impressions (priority 8 or lower) by the total number of impressions. Premium impressions are guaranteed delivery, regardless of rate type (CPD or CPM). They may include house ads, $0 revenue ads, run of site, or run-of-network ads.

In stage 1340 the overall sell-through rate can be provided to a publisher associated with the price feature set. For example, statistical analysis module 126 at pricing engine 120 may communicate the result of stage 1330 to user interface 110, which in turn may provide the result to online advertisement publisher 180.

FIG. 13B is a flowchart of an example method. The method of FIG. 13B can be performed by user interface 110, along with pricing engine 120 and data storage unit 130.

In stage 1350, a number of sold impressions for a price feature set can be calculated. The price feature set can include one or more electronic advertisement products. For example, this number of sold impressions may be calculated by statistical analysis module 126, which may use data retrieval module 124 to access information at data storage unit 130, such as historical sales metric data 130E and/or sell-through rate data 130J. This stage is similar in its implementation to stage 1310.

In stage 1360, a number of impressions displayed in advertisement slots contained in the price feature set can be calculated: For example, this number of available impressions may be calculated by statistical analysis module 126, which may use data retrieval module 124 to access information at data storage unit 130, such as historical sales metric data 130E and/or sell-through rate data 130J. Alternatively, this information may be available by analyzing product information 114 associated with products 112, where such information is stored in association with user interface 110.

In stage 1370, a targeted sell-through rate can be calculated for the price feature set based on the number of sold impressions for a price feature set and the number of impressions displayed in advertisement slots contained in the price feature set. For example, this calculation may be performed by statistical analysis module 126 at pricing engine 120. It may also be desirable to incorporate information from sell-through rate data 130J and/or to record the results at sell-through rate data 130J for future reference.

Targeted sell-through rate is the percentage of premium, non-$0, guaranteed impressions that were targeted at a particular section of inventory. The targeted impressions do not include run-of-network (RON) or run-of-service (ROS) impressions unless the targeted section is RON or ROS. All products that do not explicitly target the section are excluded (for example, if the sports section of a site does not include RON and ROS).

In stage 1380, the targeted sell-through rate is provided to a publisher associated with the price feature set. For example, statistical analysis module 126 at pricing engine 120 may communicate the result of stage 1370 to user interface 110, which in turn may provide the result to online advertisement publisher 180.

It may be noted that overall sell-through rate (provided by the method of FIG. 13A) differs from targeted sell-through rate (provided by the method of FIG. 13B) in that overall sell-through rate pertains to the ration of sold impressions to available impressions, while targeted sell-through rate pertains to sold impressions that are sold in a targeted manner.

8. Managing Rate Card

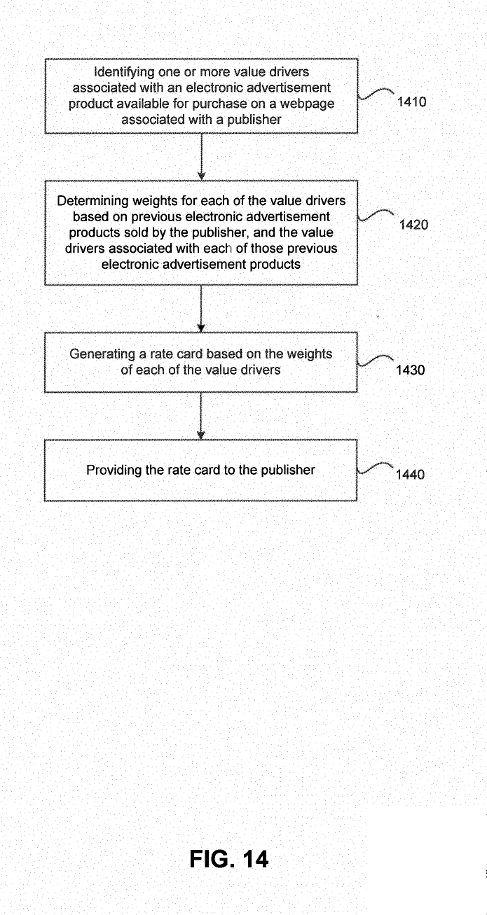

FIG. 14 is a flowchart of an example method.

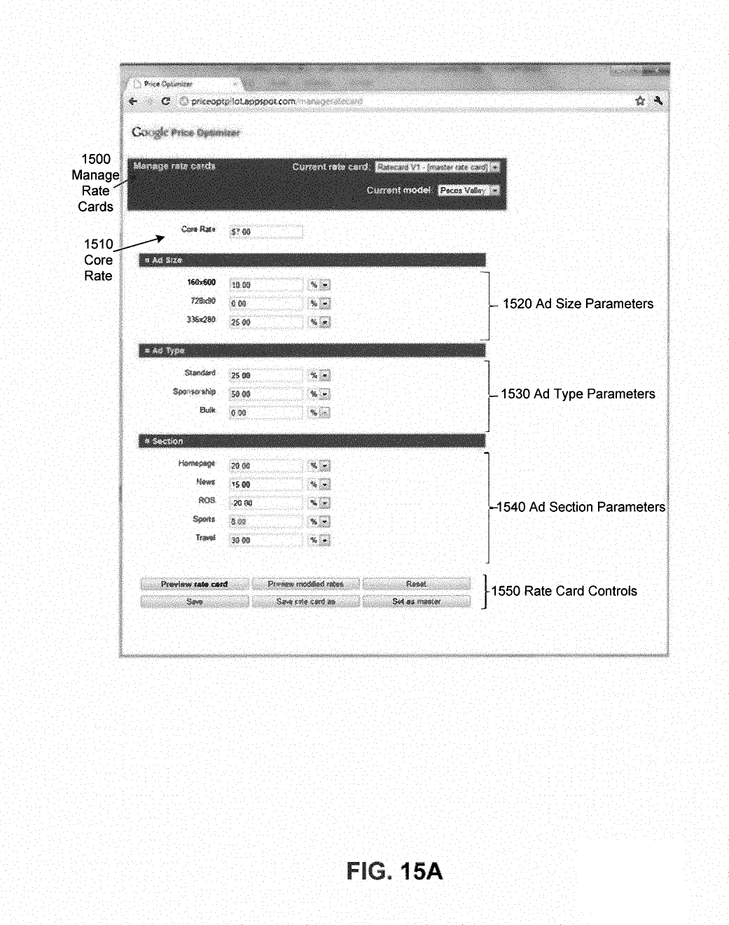

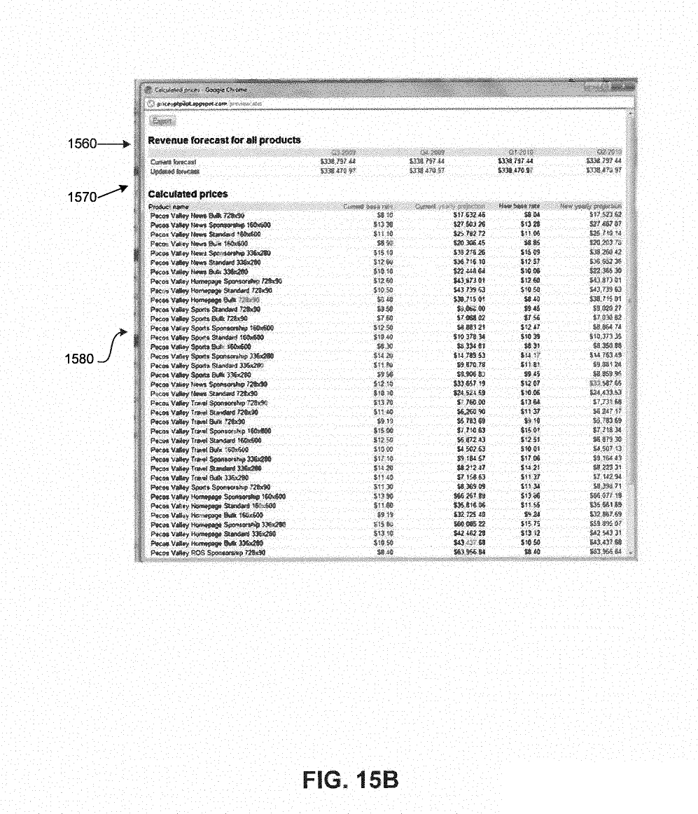

In stage 1410, one or more value drivers associated with an electronic advertisement product available for purchase on a webpage associated with a publisher are identified. Each value driver is a feature of a respective electronic advertisement product. For example, value drivers may be identified by using data retrieval module 124 at pricing engine 120 to access value driver information 130A at data storage unit 130. The nature of value drivers has been discussed above, and more information about how value drivers are defined in the context of the method of FIG. 14 will be provided by example with respect to FIGS. 15A-B.

In stage 1420, weights for each of the value drivers are determined based on previous electronic advertisement products sold by the publisher and the value drivers associated with each of those previous electronic advertisement products. For example, pricing engine 120 may cause statistical analysis module 126 to gather information related to the value drivers from data storage unit 130 by using data retrieval module 124. In another example, data retrieval module may gather information from value driver information 130A, historical pricing data 130F, advertiser specific data 130I, and other parts of data storage unit 130. Statistical analysis module 126 may use techniques, such as regression, to determine the appropriate rates for value drivers. For example, regression may reveal the value driver related to the position of a product has a larger impact than its size, and value drivers may be weighted accordingly.

In stage 1430, a rate card is generated based on the weights of each of the value drivers. The generation of the rate card may be performed by statistical analysis module 126 of pricing engine 120, based on the information gathered in stages 1410-1420. In general, statistical analysis module will generate the rate card by factoring in the value drivers as per the determined weights. For example, the rate card may produce the rate card based on a mathematical model, such that the particular value drivers are incorporated into the model, and the model can generate the information that is necessary to populate the rate card.

In stage 1440, the rate card is provided to the publisher. The rate card indicates each of the electronic advertisement products, and at least one of a list rate, a currently year projection, a new base rate, and a new yearly projection associated with the respective electronic advertisement product. The rate card will have been generated in stage 1430. Thus, for example, pricing engine 120 may cause statistical analysis module 126 to send the rate card to result transmittal module 128, which may provide the rate card as result output data 118B or as result output 116 to user interface 110, which may in turn forward the results to online advertisement publisher 180.

In one implementation, a suggested rate can be calculated for the electronic advertisement product based on a historical sell through rate. The suggested rate can be provided to the publisher. For example, the derivation of the suggested rate may be performed by statistical analysis module 126, incorporating information from data storage unit 130 by use of data retrieval module 124, drawing from data sources such as historical sales metric data 130E, historical pricing data 130F, and/or sell-through rate data 130J.

In one implementation, a core rate can be calculated from the publisher's historical sales data as a base rate to be applied to each electronic advertisement product available for purchase on the webpage associated with the publisher, wherein the suggested price of each of the electronic advertisement products will be based on the core rate and the one or more value drivers. For example, the derivation of the suggested rate may be performed by statistical analysis module 126, incorporating information from data storage unit 130 by use of data retrieval module 124, drawing from data sources such as current pricing information 130B, similar pricing information 130D, and/or economic factors 130G.

In one implementation, electronic advertisement products on a publisher webpage are identified, wherein each of the electronic advertisement products is associated with at least one of the value drivers. The rate card can be applied to the electronic advertisement products. For example, result output data 118B may be generated as discussed earlier, by gathering value driver information for a product and generating result output data 118B that provides rate information associated with the value driver information. At user interface 110, the rate card may be applied to product information 114 to result in result output 116.

In one implementation, an indication to change one of the value drivers is received. A new value for the value driver associated with the indication is received, and the value driver is updated. The value drivers include one of an advertisement size, an advertisement type, and an advertisement section. The one or more values drivers can also be selected by the publisher. This indication may be received by user interface 110 from online advertisement publisher 180, along with receiving the new value for the value driver. Updating the value driver may occur by data retrieval module 124, which may update value driver information 130A at data storage unit 130, or by performing a similar operation via product information interchange 132.

FIG. 15A is a screenshot of Manage Rate Cards, according to an embodiment. This window may be accessed from price optimizer interface 400 by selecting manage rate cards 440. The manage rate card window 1500 allows the online advertisement publisher 180 to change and manipulate information provided in rate model summary 1200. The Manage Rate Card window 1500 and the Rate Analyzer window 1200 interact, such that if the user modifies rates in Rate Analyzer window 1200 and causes the rates to affect the DSM rate, the Manage Rate Card window 1500 is updated. In addition, the Manage Rate Card window 1500 is a “fancy report” in that publishers can update rates in Rate Analyzer for each price feature set and then look at Manage Rate Card to see how much weight they gave to each price feature. This information can cause an online advertisement publisher 180 to change his rates.

Manage rate card window 1500 also allows switching between various rate cards and pricing models with dropdowns. Online advertisement publisher 180 sets a core rate 1510 for his products. The online advertisement publisher 180 then provides information for the derived value drivers. For example, there may be initially populated information regarding ad size, ad type, and ad section.

The online advertisement publisher 180 then enters information describing how his inventory is characterized and weighted with respect to these value drivers. For example, online advertisement publisher 180 may set ad size parameters 1520, ad type parameters 1530, and ad section parameters 1540. In other embodiments, other value drivers might be used. Parameters 1520, 1530, 1540 have different values displayed. These values may either be percentage or dollar-value adjustments based on the value drivers and may be positive or negative. Rate card controls 1550 provide buttons for navigating and manipulating the rate card system, including, for example, “Preview rate card” (which leads to a window as in FIG. 15B), “Preview modified rates” (which provides an overall summary of rates), “Reset” (clears rate values and restores last saved values), “Save” and “Save rate cards as” (which allow persistent storage of the rate cards) and “Set as master” (which stores the parameters as master parameters).

FIG. 15B is a screenshot of Revenue Forecast. The revenue forecast window 1560 contains information about predicted revenue for online advertisement publisher 180. The overall forecast window 1510 for all products is displayed both with “Preview rate card” and “Preview modified rates” from rate card controls 1550. However, the individual product forecast 1580 is only displayed from “Preview rate card” from rate card controls 1550.

The individual product forecast 1580 contains information about the calculated prices of products, given the value driver conditions of the model. The individual product forecast 1580 contains columns with “Product name”, “Current base rate”, “Current yearly projection”, “New base rate” and “New yearly projection.” The information contained in an individual product forecast 1580 gives online advertisement publisher 180 strategies for pricing his products effectively,

9. Pricing a New Product

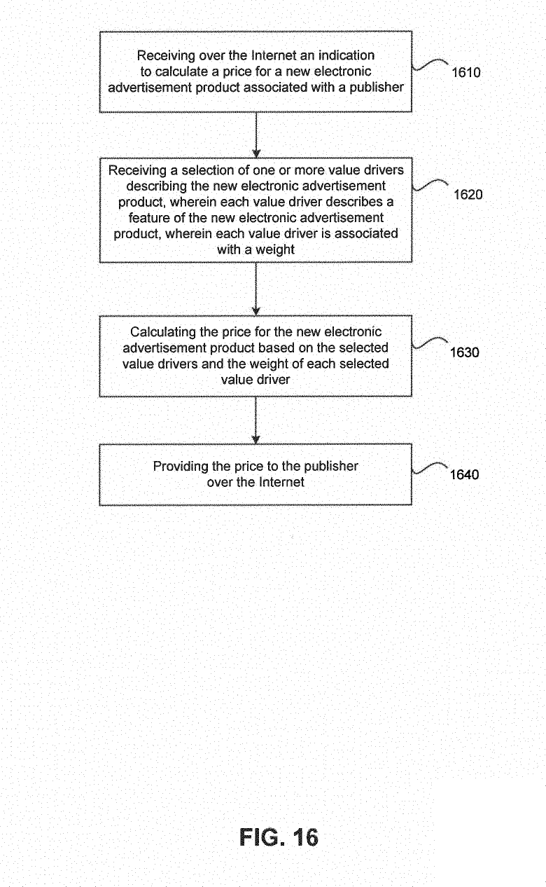

FIG. 16 is a flowchart of an example method. The method of FIG. 16 can be performed by user interface 110, along with pricing engine 120 and data storage unit 130.

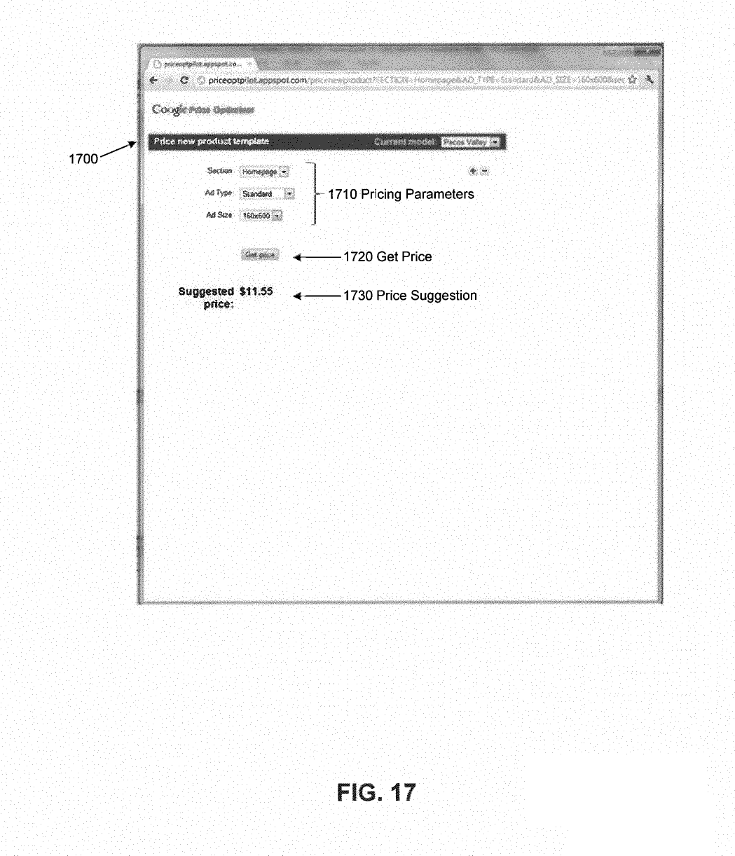

In stage 1610, an indication is received to calculate a price for a new electronic advertisement product associated with a publisher. The new electronic advertisement product is a product that can be purchased from the publisher by an advertiser. For example, user interface 110 may receive input from online advertisement publisher 180 at publisher input 112. Examples of how this may be performed will be presented in connection with FIG. 17.

In stage 1620, a selection of one or more value drivers describing the new electronic advertisement product is received. Each value driver describes a feature of the new electronic advertisement product, wherein each value driver is associated with a weight. The value drivers may include at least one of an advertisement section, an advertisement type, and an advertisement size. For example, online advertisement publisher 180 may choose value drivers as publisher input 112 to user interface 110. Additionally, it may be possible to retrieve value driver information 130A from data storage unit 130 by data retrieval module 124 at pricing engine 120.

In stage 1630, the price for the new electronic advertisement product is calculated based on the selected value drivers and the Weight of each selected value driver. The value driver information was previously accumulated, as discussed, in stage 1620. Based on this information, statistical analysis module 126 calculates the suggested price.

In stage 1640, the price is provided to the publisher over the Internet. For example, pricing engine 120 may use result transmittal module 128 to send result output data 118B to user interface 110 as result output 116. User interface can then communicate result output 116 to online publisher via network connection 190 over network 192, which may be the Internet. However, result output 116 may also be transmitted over another network 192, which may, for example be a LAN (Local Area Network) or a direct connection between user interface 110 and online advertisement publisher 180.

In one implementation, the one or more value drivers can be received from the publisher. As discussed, online advertisement publisher 180 provides publisher input 112 to user interface 110.

In one implementation, a core rate is received from the publisher. The core rate is a rate that is applied to every electronic advertisement product available for purchase on the webpage associated with the publisher. As discussed, online advertisement publisher 180 provides publisher input 112 to user interface 110.

FIG. 17 is a screenshot of Pricing Template, according to an embodiment. This window may be accessed from price optimizer interface 400 by selecting price new product template 450.

The price new product template window 1400 provides online advertisement publisher 180 with specific suggested pricings for his products. For example, online advertisement publisher 180 can select pricing parameters 1410 for specific products based on the value drivers and weights assigned in the pricing models. FIG. 14 shows a case in which a product is in the Homepage Section, is of the Standard Ad Type, and is a 160×600 Ad Size. Online advertisement publisher 180 can then select the get price button 1420, and online advertisement publisher 180 will receive a price suggestion 1430. For example, in this case, a product with these value drivers is assigned a price suggestion 1430 of $11.55.

The Summary and Abstract sections may set forth one or more but not all exemplary embodiments of the present invention as contemplated by the inventors, and thus, are not intended to limit the present invention and the appended claims in any way.

Embodiments have been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

1. In at least one computer having at least one processor and at least one memory, a method, performed by the at least one processor, of providing electronic advertisement products over the Internet, the method comprising:
receiving, by the at least one processor, and from a publisher, an identifier associated with a selection of a first advertiser by the publisher, wherein the first advertiser has previously digitally advertised on a webpage provided by the publisher;
identifying, by the at least one processor, one or more first electronic advertisement products to provide to the publisher based on the identifier, wherein the one or more first electronic advertisement products are (i) part of an online publisher inventory of available electronic advertisement products, (ii) used to display advertisement content for the first advertiser, and (iii) previously purchased by the first advertiser;
identifying a second advertiser that has previously purchased electronic advertisement products from the publisher;
identifying pricing information and purchasing information for the electronic advertisement products previously purchased by the second advertiser;
based on the pricing information and the purchasing information, determining that at least one of the previously purchased advertisement products is related to an advertisement product the first advertiser purchased;
identifying one or more second advertisement products purchased by the second advertiser from the publisher; and
providing, by the at least one processor and for display on a graphical interface, the one or more first electronic advertisement products and the one or more second electronic advertisement products to be displayed for the publisher, wherein the publisher uses the one or more first electronic advertisement products as suggested electronic advertisement products to sell to the first advertiser and uses the one or more second electronic advertisement products as additional suggested electronic products to sell to the first advertiser.

2. (canceled)

3. The method of claim 1, wherein determining that at least one of the previously purchased advertisement products is related to an advertisement product the first advertiser purchased comprises:
determining that the at least one of the previously purchased electronic advertisement products is the same as an electronic advertisement product the first advertiser purchased.

4-18. (canceled)

19. The method of claim 1, wherein determining that at least one of the previously purchased advertisement products is related to an advertisement product the first advertiser purchased comprises:
performing regression analysis on the pricing information and the purchasing information; and
based on the regression analysis, determining that at least one of the previously purchased advertisement products is related to an advertisement product the first advertiser purchased.

20. The method of claim 19, wherein performing regression analysis on the pricing information and the purchasing information comprises determining linear relationships among the pricing information and the purchasing information.

21. The method of claim 19, wherein performing regression analysis on the pricing information and the purchasing information comprises determining log-linear relationships among the pricing information and the purchasing information.

22. The method of claim 1, wherein determining that at least one of the previously purchased advertisement products is related to an advertisement product the first advertiser purchased comprises:
determining that the at least one of the previously purchased advertisement products is in a subset of at least one of the advertisement products the first advertiser purchased.

23. The method of claim 1, wherein determining that at least one of the previously purchased advertisement products is related to an advertisement product the first advertiser purchased comprises:
determining that the at least one of the previously purchased advertisement products is in a superset of at least one of the advertisement products the first advertiser purchased.

24. A computing device comprising:
one or more storage devices storing instructions that are operable, when executed by the computing device, to cause the computing device to perform operations comprising:
receiving, from a publisher, an identifier associated with a selection of a first advertiser by the publisher, wherein the first advertiser has previously digitally advertised on a webpage provided by the publisher;
identifying one or more first electronic advertisement products to provide to the publisher based on the identifier, wherein the one or more first electronic advertisement products are (i) part of an online publisher inventory of available electronic advertisement products, (ii) used to display advertisement content for the first advertiser, and (iii) previously purchased by the first advertiser;
identifying a second advertiser that has previously purchased electronic advertisement products from the publisher;
identifying pricing information and purchasing information for the electronic advertisement products previously purchased by the second advertiser;
based on the pricing information and the purchasing information, determining that at least one of the previously purchased advertisement products is related to an advertisement product the first advertiser purchased;
identifying one or more second advertisement products purchased by the second advertiser from the publisher; and
providing, for display on a graphical interface, the one or more first electronic advertisement products and the one or more second electronic advertisement products to be displayed for the publisher, wherein the publisher uses the one or more first electronic advertisement products as suggested electronic advertisement products to sell to the first advertiser and uses the one or more second electronic advertisement products as additional suggested electronic products to sell to the first advertiser.

25. The system of claim 24, wherein determining that at least one of the previously purchased advertisement products is related to an advertisement product the first advertiser purchased comprises:
determining that the at least one of the previously purchased electronic advertisement products is the same as an electronic advertisement product the first advertiser purchased.

26. The system of claim 24, wherein determining that at least one of the previously purchased advertisement products is related to an advertisement product the first advertiser purchased comprises:
performing regression analysis on the pricing information and the purchasing information; and
based on the regression analysis, determining that at least one of the previously purchased advertisement products is related to an advertisement product the first advertiser purchased.

27. The system of claim 26, wherein performing regression analysis on the pricing information and the purchasing information comprises determining linear relationships among the pricing information and the purchasing information.

28. The system of claim 26, wherein performing regression analysis on the pricing information and the purchasing information comprises determining log-linear relationships among the pricing information and the purchasing information.

29. The system of claim 24, wherein determining that at least one of the previously purchased advertisement products is related to an advertisement product the first advertiser purchased comprises:
determining that the at least one of the previously purchased advertisement products is in a subset of at least one of the advertisement products the first advertiser purchased.

30. The system of claim 24, wherein determining that at least one of the previously purchased advertisement products is related to an advertisement product the first advertiser purchased comprises:
determining that the at least one of the previously purchased advertisement products is in a superset of at least one of the advertisement products the first advertiser purchased.

31. A non-transitory computer-readable medium storing software comprising instructions executable by one or more computers which, upon such execution, cause the one or more computers to perform operations comprising:
receiving, from a publisher, an identifier associated with a selection of a first advertiser by the publisher, wherein the first advertiser has previously digitally advertised on a webpage provided by the publisher;
identifying one or more first electronic advertisement products to provide to the publisher based on the identifier, wherein the one or more first electronic advertisement products are (i) part of an online publisher inventory of available electronic advertisement products, (ii) used to display advertisement content for the first advertiser, and (iii) previously purchased by the first advertiser;
identifying a second advertiser that has previously purchased electronic advertisement products from the publisher;
identifying pricing information and purchasing information for the electronic advertisement products previously purchased by the second advertiser;
based on the pricing information and the purchasing information, determining that at least one of the previously purchased advertisement products is related to an advertisement product the first advertiser purchased;
identifying one or more second advertisement products purchased by the second advertiser from the publisher; and
providing, for display on a graphical interface, the one or more first electronic advertisement products and the one or more second electronic advertisement products to be displayed for the publisher, wherein the publisher uses the one or more first electronic advertisement products as suggested electronic advertisement products to sell to the first advertiser and uses the one or more second electronic advertisement products as additional suggested electronic products to sell to the first advertiser.

32. The medium of claim 31, wherein determining that at least one of the previously purchased advertisement products is related to an advertisement product the first advertiser purchased comprises:
determining that the at least one of the previously purchased electronic advertisement products is the same as an electronic advertisement product the first advertiser purchased.

33. The medium of claim 31, wherein determining that at least one of the previously purchased advertisement products is related to an advertisement product the first advertiser purchased comprises:
performing regression analysis on the pricing information and the purchasing information; and
based on the regression analysis, determining that at least one of the previously purchased advertisement products is related to an advertisement product the first advertiser purchased.

34. The medium of claim 33, wherein performing regression analysis on the pricing information and the purchasing information comprises determining linear relationships among the pricing information and the purchasing information.

35. The medium of claim 33, wherein performing regression analysis on the pricing information and the purchasing information comprises determining log-linear relationships among the pricing information and the purchasing information.

36. The medium of claim 31, wherein determining that at least one of the previously purchased advertisement products is related to an advertisement product the first advertiser purchased comprises:
determining that the at least one of the previously purchased advertisement products is in a subset or a superset of at least one of the advertisement products the first advertiser purchased.
